(19) United States
(12) Patent Application Publication
(10) Pub. No.: US 2009/0034683 A1
(43) Pub. Date: Feb. 5, 2009

(54) RADIATION IMAGE ACQUISITION APPARATUS AND RADIATION IMAGE ACQUISITION SYSTEM

(75) Inventor: Yasuaki Tamakoshi, Tokyo (JP)

Correspondence Address: CANTOR COLBURN, LLP, 20 Church Street, 22nd Floor, Hartford, CT, 06103, US

(73) Assignee: KONICA MINOLTA MEDICAL & GRAPHIC, INC., Tokyo (JP)

(21) Appl. No.: 11/909,664

(22) PCT Filed: Mar. 27, 2006
(86) PCT No.: PCT/JP2006/306144

§ 371 Date: Sep. 25, 2007

(30) Foreign Application Priority Data
Mar. 25, 2005 (JP) 2005-089058

(51) Int. Cl. H05G 1/08

(52) U.S. Cl. 378/91

(57) ABSTRACT

Disclosed a radiation image apparatus including: a radiation image acquiring unit to acquire radiation image data by radiation radiography; a first communication unit to transmit the radiation image data acquired by the radiation image acquiring unit from a first antenna by an electric wave having a frequency exceeding 1 GHz; and
a second communication unit to transmit the radiation image data acquired by the radiation image acquiring unit from a second antenna located at a position different from that of the first antenna by an electric wave.

### TECHNICAL FIELD

The present invention relates to a radiation image acquisition apparatus and a radiation image acquisition system.

### BACKGROUND ART

Radiation images as typified by X-ray images have been conventionally used for medical diagnoses widely. A radiation image means an image acquired by radiating radiations, such as X rays, to a subject, and by detecting the intensity distribution of the radiations that has transmitted the subject.

A radiographing apparatus using computed radiography (CR) or a film to acquire a radiation image has been known. However, because a radiation image acquisition system using the CR needs a long time from several tens of seconds to several minutes for generating radiographed radiation image data from radiating radiations, even if radiography has been failure as a result of confirming an image, the subject has been already clothed, out of the radiographing room, or out of the department of radiology for the confirmation time, and it has been troublesome to request re-radiography.

Accordingly, in recent years, there has been proposed a radiation image acquisition system using a flat panel detector (FPD), which detects the radiations that have transmitted a subject to convert the radiations into an electric signal and stores the electric signal therein as radiation image information, in order to acquire a radiation image. The radiation image acquisition system using the FPD can generate radiation image data of a radiographed image for a short time of several seconds from radiating radiations.

Moreover, the technique related to a radiation image acquisition apparatus including a built-in FPD, a wireless communication section, and an internal power source was disclosed (see, for example, Patent Document 1). The radiation image acquisition apparatus having no wiring can perform wireless communication with a console, and can supply electric power by itself from the internal power source in the radiation image acquisition apparatus. Moreover, the radiation image acquisition apparatus has the advantages that the handling performance thereof is high and it can be freely carried.

Furthermore, there was disclosed the technique related to a radiation image acquisition apparatus further including a connector enabling the connection thereof with either a wireless module or a cable besides a wireless communication section and an internal power source (see, for example, Patent Document 2). The technique enables an operator to select either of the radiography of a radiation image in the cable-less state in which the radiation image acquisition apparatus is connected to the wireless module and has a high handling performance and the continuous radiography of many images without considering the storage capacity thereof in the state of being connected with a cable.

Moreover, there was disclosed the technique of an X-ray cassette including an antenna for electric wave communication, which technique changed a radio frequency with frequency changing means while performing a frequency search for checking a peripheral electric wave condition to enable changing the transmission frequency (radio channel) of electric wave communication on the basis of the frequency search result with the frequency changing means (see, for example, Patent Document 3).

Moreover, there was disclosed the technique of an X-ray cassette including an antenna for wireless communication, which technique automatically adjusted the direction of the antenna so that the reception sensitivity thereof might become the optimum. There was also disclosed the technique of providing an indicator indicating the level of sensitivity in order to enable the visual recognition of the reception sensitivity thereof, and an antenna at the tip of a flexible cable so that the antenna might be able to be placed at an arbitrary position (see, for example, Patent Document 4).

### Patent Document 1: Japanese Patent Application Laid-Open Publication No. 2004-180931

Patent Document 2: Japanese Patent Application Laid-Open Publication No. 2004-173907 (corresponding United States Patent Published Application No. 2004-114725)

### Patent Document 3: Japanese Patent Application Laid-Open Publication No. 2005-13310

### Patent Document 4: Japanese Patent Application Laid-Open Publication No. 2003-210444

### DISCLOSURE OF THE INVENTION

### Problem to be Solved by the Invention

However, if the radiation image acquisition apparatus is in the cable-less state by the techniques described in the Patent Documents 1 and 2, the state has the problem in which the communication between a radiation image acquisition apparatus and a console easily becomes impossible according to the arrangement of a subject and the radiation image acquisition apparatus in comparison with the cable communication.

It is needless to say that the output power of the electric waves of electric wave communication is limited for a subject and by the restriction of a law in the case of the equipment used in the state of being close to or stuck fast to a human body, such as the radiation image acquisition apparatus (especially a cassette).

In particular, in the case of the wireless communication using the electric waves having the frequencies larger than 1 GHz, wireless electric waves are reflected by a ceiling, a wall, a floor, a shelf, and the like, and the direct waves and the reflected waves of the electric waves are composed to be mutually intensified or weakened. In particular, if the electric wave paths of the reflected waves is lengthened by odd number multiples of the half-wave lengths of the electric wave paths of the direct waves so that the reflected waves and the direct waves become inverted mutually, then the direct wave and the reflected waves are mutually negated to cause communication poor condition. That is, the “multi pass fading,” which is the composing of various reflected waves occurs.

Moreover, because an electric wave having a frequency exceeding 1 GHz has a propagation characteristic similar to that of a light, the “shadowing,” which is the phenomenon of electric wave's difficulty of reaching the shadow of a obstacle, also occurs.

Then, a cassette is frequently provided with an X-ray shielding member made of an electroconductive material and a housing made of an electroconductive material lest X-ray scatterings at a circuit and the like should influence an X-ray radiography image. In this case, because it is difficult to increase the distance between the antenna for wireless communication of a cassette and the housing thereof and the distance between the antenna for wireless communication and the X-ray shielding member of the cassette, directivity inevitably arises. Moreover, equipment other than a cassette, such as a radiographic stand for placing a cassette for radiography, which equipment is made of an electroconductive material, is sometimes disposed in the neighborhood of the cassette. Accordingly, in X-ray radiography using a cassette, communication poor condition may arise owing to the equipment made of an electroconductive material, a subject, and the like, which are obstacles of the communication, or the communication poor condition may arise owing to the directivity of a wireless communication section, without delicately adjusting the arrangement relation between the subject and the cassette, and the arrangement relation between the equipment made of the electroconductive material and the cassette.

Moreover, the techniques described in the Patent Documents 3 and 4 do not consider providing a plurality of antennas for electric wave communication into an X-ray cassette. Moreover, the technique described in the Patent Document 4 automatically adjusts the direction of an antenna, but only the adjusting of the direction remains the problems of the impossibility of fully settling the multi pass fading problem and the shadowing arising problem. Moreover, the technique described in the Patent Document 4 has the problem of the occurrence of the re-adjustment of an antenna position when the antenna position has changed during a period of from the setting of the poison and the like of the antenna to the exposure of radiations of X rays, and the problem of the occurrence of the necessity of adjusting the antenna position to the optimum one every change of the position of a subject and the position and the direction of a cassette at the time of radiography. Consequently, the efficiency of radiography can be deteriorated.

The present invention was devised for settling the problems mentioned above.

### BRIEF DESCRIPTION OF THE DRAWINGS

FIG. 1 is a diagram showing the schematic configuration of an X-ray image acquisition system in a first embodiment;

FIG. 2A is a view showing the schematic configuration of a cassette in the first embodiment, the cassette provided with a plurality of antennas and a single communication circuit;

FIG. 2B is a view showing the schematic configuration in the first embodiment, the cassette provided with the plurality of antennas and a plurality of communication circuits;

FIG. 3 is a perspective view showing the schematic configuration of one embodiment of the cassette in the first embodiment;

FIG. 4 is a sectional view of the one embodiment of the cassette, where the panel is centered, in the first embodiment;

FIG. 5 is a circuit diagram showing the configuration of one embodiment of a circuit laying stress on photodetectors in the first embodiment;

FIG. 6 is a diagram showing the schematic configuration of an X-ray image acquisition system in a second embodiment;

FIG. 7 is an arrangement view laying stress on the cassette in the first embodiment and a patient who is a subject; and

FIG. 8 is another arrangement view laying stress on the cassette in the first embodiment and the patient, who is the subject.

### BEST MODE TO CARRY OUT THE INVENTION

In the following, terms are explained.

A radiation means an electromagnetic wave and a particle beam that have strong ionization operation and fluorescent operation, and includes an X ray, a γ ray, β ray, an α ray, a proton beam, a deuteron beam and the other heavy charged particle beams, and a neutron beam. In the present invention, as a radiation, an electron beam, an X ray, and a γ ray are preferable, and especially the X ray is preferably.

A console means an apparatus for an operator to communicate with a cassette. The console may be capable of being connected with a display apparatus and an operation apparatus, both of which are separated bodies from the console, or the display apparatus and the operation apparatus may be integrated with the console.

In the following, the embodiments of the present invention will be described with reference to the attached drawings. Incidentally, it is needless to say that the present invention is not limited to these embodiments.

The description of the embodiment column of the invention shows the best modes for executing the invention, which the inventor recognizes as the best. Although there are the expressions apparently concluding or defining the terms used in the scope of the invention and claims, these expressions are the ones for specifying the modes which the inventor recognizes as the best to the last, and do not specify or restrict the terms used in the scope of the invention and the claims.

### FIRST EMBODIMENT

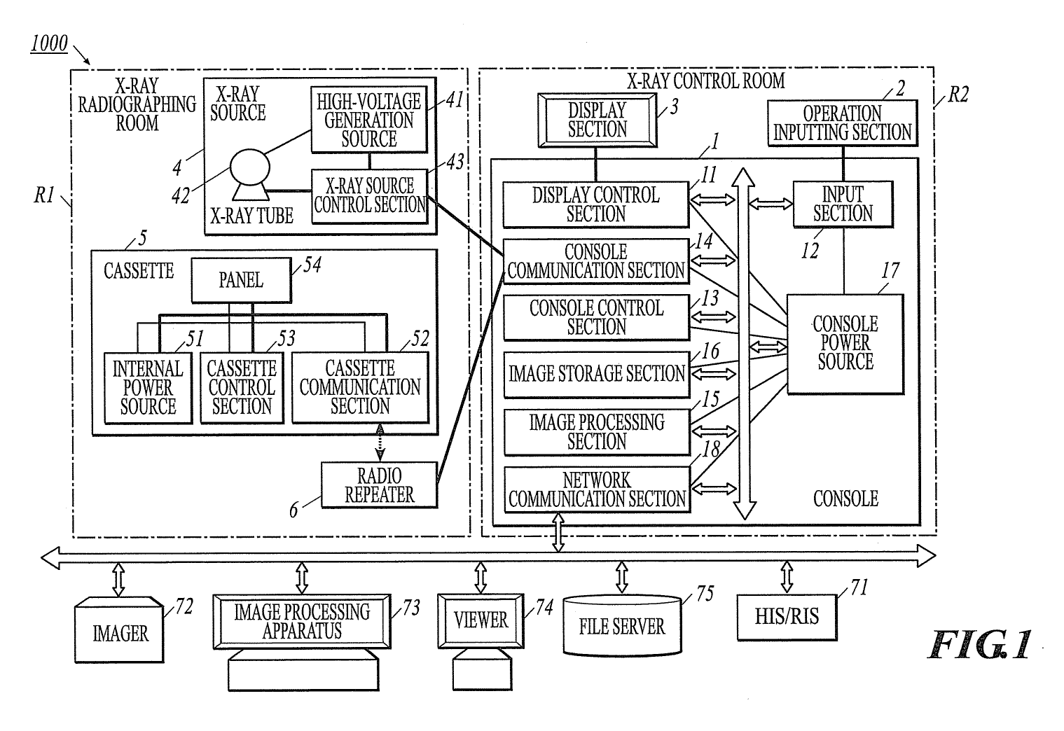

A first embodiment of the X-ray image acquisition system according to the present invention is described with reference to FIGS. 1-5. Incidentally, an X ray is a kind of radiations. Moreover, a cassette housing a flat panel detector (FPD) is a kind of an X-ray image acquisition apparatus.

As shown in FIG. 1, the X-ray image acquisition system 1000 according to the first embodiment is a system supposing an X-ray image acquirement operation in a hospital, and is disposed in, for example, an X-ray radiographing room R1 for radiating X rays to a subject and an X-ray control room R2 in which an X-ray technician performs the control of X rays to be radiated to the subject, the image processing of an X-ray image acquired by radiating the X rays, and the like.

A console 1 is installed in the X-ray control room R2. The whole of the X-ray image acquisition system is controlled by the console 1, and the control of X-ray image acquirement and the image processing of the acquired X-ray image are performed.

An operation inputting section 2 for an operator to input a radiography preparation instruction, a radiography instruction, and an instruction content is connected to the console 1. As the operation inputting section 2, it is possible to use, for example, an X-ray radiation requesting switch, a touch panel, a mouse, a keyboard, a joy stick, and the like. Through the operation inputting section 2, the console 1 receives the input of the following instruction contents: X-ray radiography conditions, such as an X-ray tube voltage, an X-ray tube current, and an X-ray radiating time; X-ray radiography controlling conditions, such as radiography timing, a radiography part, and a radiography method; image processing conditions; image outputting conditions; cassette selection information; order selection information; a subject ID; and the like.

Furthermore, a display section 3 for displaying an X-ray image and the like is connected to the console 1, and the display of the display section 3 is controlled by a display control section 11 constituting the console 1. As the display section 3, for example, a monitor, such as a liquid crystal monitor and a cathode ray tube (CRT) monitor, a sheet of electronic paper, and an electronic film can be used. The display section 3 displays characters, such as X-ray radiography conditions and image processing conditions, and X-ray images by the control of the display control section 11 of the console 1.

Moreover, the console 1 includes the display control section 11, an input section 12, a console control section 13, a console communication section 14, an image processing section 15, an image storage section 16, a console power source section 17, a network communication section 18, and the like. The display control section 11, the input section 12, the console control section 13, the console communication section 14, the image processing section 15, the image storage section 16, the console power source section 17, and the network communication section 18 are severally connected to a bus, and they can perform data interchanges.

The input section 12 receives an instruction content from the operation inputting section 2.

The console control section 13 determines radiography conditions on the basis of the instruction content, which the input section 12 has received from the operation inputting section 2, and order information, which the network communication section 18 has received from an HIS/RIS 71. Then, the console control section 13 controls the console communication section 14 to transmit radiography condition information pertaining to the radiography conditions to an X-ray source 4 and a cassette 5 as a radiographing signal, and to suitably transmit radiographing signals necessary for radiography. Thereby, the console control section 13 controls the X-ray source 4 and the cassette 5 to perform X-ray radiography.

Moreover, the console control section 13 allows the image storage section 16 temporarily to store the X-ray image data that the console communication section 14 has received from the cassette 5. Moreover, the console control section 13 controls the image processing section 15 to generate thumbnail image data from the X-ray image data stored in the image storage section 16 temporarily. The display control section 11 controls the display section 3 to display a thumbnail image on the basis of the generated thumbnail image data. Then, the console control section 13 controls the image processing section 15 to perform image processing to the X-ray image data on the basis of the instruction content received by the input section 12 and the order information of the HIS/RIS 71, and to store the X-ray image data subjected to the image processing into the image storage section 16. Then, the console control section 13 controls the display control section 11 to display the thumbnail image of the processing result on the basis of the X-ray image data of the result of the image processing of the image processing section 15. Furthermore, the console control section 13 performs the following operations: allowing the image processing section 15 to perform the re-image processing of the X-ray image data on the basis of the instruction content received from the operation inputting section 2 by the input section 12 after image processing by the image processing section 15, controlling the display control section 11 to allow the display section 3 to display the display of the image processing result, and controlling the network communication section 18 to allow an external apparatus on a network to transfer, store, and display the X-ray image data.

Moreover, the console control section 13 has a function of managing the channel through which the cassette 5, which is radiation image acquiring means, performs transmission and the channel through which the other equipment performs transmission by a microwave. That is, while the cassette 5 wirelessly performs transmission through a predetermined channel, the console control section 13 performs its control lest the other equipment should perform wireless transmission through this predetermined channel to cause radio interference. For example, the console control section 13 is configured to acquire the channel information of wireless communication, which channel information can be acquired from the antenna of a radio repeater 6 connected to the console communication section 14 with a communication cable, through the radio repeater 6 when a new equipment is introduced, or always, to confirm and store which channel the other equipment uses. Then, if the channel of the other equipment and the channel used for the cassette 5 coincide with each other, the console control section 13 performs the control so as to change the channel of the cassette 5, when possible, or to change the channel of the other equipment when possible. Moreover, if it is impossible to change each channel, the console control section 13 controls the display control section 11 so that the display section 3 may perform a warning display expressing not to use the other equipment at the time of the transmission of radiation X-ray image data.

As the console control section 13, it is possible to apply a motherboard installing a central processing unit (CPU) and memories, such as a random access memory (RAM) and a read only memory (ROM).

The CPU reads a program stored in the ROM or a hard disk, and expands the program on the RAM to control each section of the console 1, the X-ray source 4, the cassette 5, and the external apparatus in accordance with the expanded program. Moreover, the CPU reads various pieces of processing programs including a system program, all of which are stored in the ROM or the hard disk, to expand on the RAM and execute various pieces of processing, which will be described later.

The RAM is a volatile memory, and forms a work area to temporarily store various programs that are read from the ROM and can be executed by the CPU, input data, output data, and the like in various pieces of processing that is controlled to be executed by the CPU of the console control section 13.

The ROM is, for example, a nonvolatile memory, and stores the system program, various programs corresponding to the system program, and the like, which are executed by the CPU. These various programs are stored in the form of readable program codes, and the CPU sequentially executes the operations in accordance with the program codes.

Moreover, a hard disk may be used in place of the ROM. In this case, the hard disk stores the system program and various application programs, which are executed by the CPU. Moreover, a part or the whole of the hard disk may receive and store various application programs, such as the program of the present invention, through the console communication section 14 and a transmission medium of a network line from another equipment such as a server. Furthermore, the CPU may also receive various application programs, such as the programs of the present invention, from a storage apparatus, such as the hard disk of the server, provided on the network, expand the received application programs on the RAM, and perform various kinds of processing, such as that of the present invention.

The display control section 11 controls the display section 3 to display an image, a character, and the like, based on image data, character data, and the like, under the control of the console control section 13. A graphic board or the like can be used as the display control section 11.

The console communication section 14 is connected to the X-ray source 4 and the radio repeater 6 severally through a communication cable, and the console communication section 14 can communicate with the cassette 5 through the radio repeater 6. The console communication section 14 can transmit radiographing signals, such as various control signals and various pieces of information, based on the instruction contents from the console control section 13 to X-ray source 4 and the cassette 5 by analog communication or digital communication, and on the other hand can receive radiographing signals, such as X-ray image data, various control signals, and various pieces of information from the cassette 5.

If the console communication section 14 is instructed by the console control section 13 to transmit a radiographing signal for acquiring X-ray image data by X-ray radiography, then the console communication section 14 allows the radio repeater 6 to output a radiographing signal in the form of an electric wave. As such radiographing signals transmitted from the console communication section 14, for example, the radiography condition information pertaining to the radiography conditions; a radiography preparation instruction signal for shifting a state from a sleep mode, which will be described later, and a radiography waiting state to a radiography capable state; and a radiography instructing signal instructing X-ray radiography can be cited. Moreover, as the radiographing signals that the console communication section 14 receives from the cassette 5, for example, a radiography capable state shift signal indicating the shift of the cassette 5 to the radiography capable state, a preparation end signal indicating the state of the cassette 5 capable of receiving the radiation of X rays to acquire X-ray image data, and an X-ray radiation ending signal indicating that an X-ray radiation quantity has reached a predetermined quantity can be cited.

The radio repeater 6 can detect the communication condition of wireless communication of each of the communication using an electric wave from the cassette 5, which communication will be described later, on the basis of a fall of the received electric wave intensity of the wireless communication, a noise quantity of the wireless communication band, and the like. In this case, the radio repeater 6 transmits the information of the communication condition of the wireless communication between a cassette communication section 52 and the radio repeater 6, which communication condition has been detected by the radio repeater 6, to the console communication section 14. When the console communication section 14 receives the information, the console control section 13 detects the communication condition of the wireless communication.

On the other hand, while the console communication section 14 is detecting X-ray image data being received from the cassette 5, that is, when the console communication section 14 is receiving the X-ray image data from the cassette 5, the console control section 13 controls the display control section 11 to allow the display section 3 to display that the X-ray image data is receiving. Then, if the console control section 13 detects a communication impossible condition of the wireless communication from the cassette 5 by the electric wave when the display section 3 displays that the X-ray image data is receiving, the console control section 13 controls the display control section 11 to allow the display section 3 to stop the display showing the receiving of the X-ray image data.

Then, when the console control section 13 detects a failed condition of the wireless communication between the cassette communication section 52 and the radio repeater 6 with respect to each communication from the cassette 5 by an electric wave, that is, when the console control section 13 detects that the wireless communication is in a communication poor condition, the console control section 13 controls the display control section 11 to allow the display section 3 to perform the display showing the communication poor condition of the wireless communication. The display showing the communication poor condition may be any of a display showing the communication poor condition; a display of a communication speed, the absolute value, the relative value, the level, or the like, of the intensity of a wireless communication wave (electric wave intensity, received light intensity, or the like); a display of the absolute value, the relative value, the level, or the like, of a S/N ratio; and another mode display.

For example, the following method like the display showing the reception condition of a cellular phone in an information area of a task bar of Windows (registered trademark) can be cited: a display indicating a good communication condition shows an antenna sign and three standing indicators; a display indicating a communication poor condition shows the antenna sign and two or one standing indicator according to the degree of the communication poor condition; and a display indicating a communication impossible condition shows the antenna sign and no standing indicators. An easily understandable display method may be suitably used.

Moreover, as a modification, the console communication section 14 may generate an analog signal for wireless transmission from a digital signal and to convert a wirelessly received analog signal into a digital signal; and the radio repeater 6 may be an antenna of the console communication section 14, and perform wireless transmission using the analog signal for wireless transmission from the console communication section 14 and to transmit the wirelessly received analog signal to the console communication section 14. In this case, the communication condition of the wireless communication can be detected by the console communication section 14 on the basis of a fall of received electric wave intensity of the wireless communication, a noise quantity in the wireless communication band, and the like. In this case, the information of the communication condition of the wireless communication between the cassette communication section 52 and the radio repeater 6, which communication condition has been detected by the console communication section 14, is transmitted to the console control section 13, and the console control section 13 detects the communication condition of the wireless communication.

The image processing section 15 performs the image processing of the X-ray image data that the console communication section 14 has received from the cassette 5. The image processing section 15 performs the image processing, such as the correction processing, the expansion and compression processing, the spatial filtering processing, the recursive processing, the gradation processing, the scattered radiation correction processing, the grid correction processing, the frequency emphasizing processing, the dynamic range (DR) compressing processing, and the like, of image data on the basis of instruction contents.

The image storage section 16 includes a storage apparatus to store X-ray image data, and temporarily stores the X-ray image data that the console communication section 14 has received from the cassette 5 and stores the X-ray image data that has received image processing. As the image storage section 16, a hard disk, which is a large-capacity and high-speed storage apparatus, a hard disk array, such as a redundant array of independent disks (RAID), a silicon disk, and the like can be used.

The console power source section 17 is supplied with electric power from an external power source (not shown), such as an AC power source, or an internal power source (not shown), such as a battery and a battery cell, and supplies electric power to each section constituting the console 1.

The external power source of the console power source section 17 is detachably attachable. When the console power source section 17 receives the supply of electric power from the external power source, charging is not necessary. Consequently, it is possible to perform radiography for a long time.

The network communication section 18 performs the communication of various pieces of information between console 1 and the external apparatus by a local area network (LAN). As the external apparatus, for example, a hospital information system/radiology information system (HIS/RIS) terminal 71, an imager 72, an image processing apparatus 73, a viewer 74, a file server 75, and the like, can be connected. The network communication section 18 outputs X-ray image data to the external apparatus in accordance with a predetermined protocol, such as the Digital Imaging and Communications in Medicine (DICOM).

The HIS/RIS terminal 71 acquires the information of a subject, a radiography part, a radiography method, and the like, from the HIS/RIS, and provides the acquired information to the console 1. The imager 72 records an X-ray image on an image recording medium, such as a film, on the basis of X-ray image data output from the console 1. The image processing apparatus 73 performs the image processing of X-ray image data output from the console 1 and the processing for computer aided diagnosis (CAD) so as to store the processed data into the file server 75. The viewer 74 displays an X-ray image on the basis of the X-ray image data output from the console 1. The file server 75 is a file server to store the X-ray image data received the image processing. The network communication section 18 outputs the X-ray image data to the external apparatus in accordance with the predetermined protocol, such as the Digital Imaging and Communications in Medicine (DICOM).

Incidentally, the present embodiment concerns the example of providing the display control section 11 and the console control section 13 as separated bodies, but the display control section and the console control section may be provided as one body. For example, a configuration can be cited in which a motherboard on which a CPU and a memory are installed is used as the console control section, and a graphic sub system built in the motherboard is used as the display control section. Moreover, the console control section 13 may also function as the display control section. Moreover, although the image processing section 15 is separated from the console control section 13 in the present embodiment, the console control section 13 may also function as the image processing section.

In the X-ray radiographing room R1, the X-ray source 4 radiating X rays to a subject and the cassette 5 detecting the X rays radiated to the subject to acquire an X-ray image data are arranged. The X-ray radiographing room R1 is formed as a room covered by an X-ray shielding member lest the X rays of the X-ray source 4 should leak to the outside of the X-ray radiographing room R1, and the cassette 5 is configured to be portable to be taken out to the outside of the X-ray radiographing room R1.

Furthermore, the radio repeater 6 is installed in the X-ray radiographing room R1. The radio repeater 6 performs wireless communication with the cassette 5. To put it concretely, the radio repeater 6 performs communication using an electric wave. Consequently, a cable for communication is unnecessary for the communication between the cassette 5 and the radio repeater 6, and the situation can be avoided in which the cassette 5 is handled with attention so that the cable may not twine around a subject at the time of X-ray radiography.

Moreover, the radio repeater 6 communicates with the console 1 through a communication cable. Then, the X-ray image data acquired by the cassette 5 is transmitted to the console 1 through the radio repeater 6, and control signals and various pieces of informations are communicated between the console 1 and the cassette 5.

Then, a plurality of radio repeaters 6 is preferably installed in the X-ray radiographing room R1 to enable the cassette 5 and the console 1 to communicate with each other through any of the radio repeaters 6. Thereby, the possibility of the occurrence of the multi pass fading and the shadowing in all the combinations of the plurality of radio repeaters 6 and a plurality of antennas 521 (which will be described later) becomes further lower.

Incidentally, as the methods of communication using electric waves, there can be cited a method of transmitting an electric wave having a frequency exceeding 1 GHz and a method of performing communication using an electric wave having a frequency equal to 1 GHz or less. The method of performing communication using an electric wave having a frequency exceeding 1 GHz is preferable for the communication to transmit the radiation image data acquired by the radiation image acquiring means of the present invention.

There are the following methods as the method of transmitting an electric wave having a frequency exceeding 1 GHz: the method of using a wireless LAN fitted to the 156 Mbps totally double (312 Mbps) wireless LAN standard (ARIB STD-T74) using, for example, a 60 GHz band or the RCR STD-34 standard capable of high speed (25 Mbps) communication using a 19 GHz band; the method of using a fixed wireless access (FWA) using a 18 GHz band, the 19 GHz band, and the like; the method by a next-generation cellular phone using a 1.4 GHz band, a 2 GHz band, a 2.1 GHz band, and the like; the method by a wireless LAN fitted to the standards, such as IEEE 802.11a, 802.11b, 802.11g, and the like, using 2.4 GHz band, 5.2 GHz band, and the like; the method based on a wireless communication standards such as the Bluetooth using 2.45 GHz band and Home Radio Frequency (Home RF) using a 2.4 GHz band; the communication method using an ultra wide band (UWB), namely an ultra wide band electric wave; the method of using the Industrial, Scientific and Medical (ISBM) band using the 2.4 GHz band, a 5.8 GHz, and the like; and the like. Moreover, as the electric wave having the frequency exceeding 1 GHz, the electric wave having a frequency equal to 2 GHz or more (especially 5 GHz or more) is preferable from the viewpoint of an information transmission capacity. Moreover, the electric wave having a frequency equal to 3×10² GHz or less (especially 3×10 GHz or less) is preferable from the viewpoints of lowering the cost and miniaturizing the communication circuit.

Moreover, there can be cited the following methods as the method of performing communication using an electric wave having a frequency equal to 1 GHz or less: the method by specific low-power radio using, for example, a 7×10 MHz band or a 4×10² MHz band, the method by PHS, the method by cellular phone using a 8×10² MHz band or a 9×10² MHz band, and the like. As the electric wave having a frequency equal to 1 GHz or less, an electric wave having a frequency equal to 8×10² MHz or less (especially 4×10² MHz or less) is preferable from the viewpoint of the diffraction of the electric wave. Moreover, an electric wave having a frequency equal to 3×10 MHz or more (especially 1×10² MHz or more) is preferably from the viewpoint of miniaturizing the antenna.

Moreover, wireless communication between the console 1 and the cassette 5 using these electric waves may be in a mode in which the console 1 and the cassette 5 directly perform wireless communication, or may be in a mode in which a radio repeater is provided between them to perform wireless communication through the radio repeater. Moreover, the wireless communication using these electric waves may be analog communication or digital communication.

As described above, the present embodiment is configured to install the cassette 5 and the radio repeater 6 in the inner part of the X-ray radiographing room R1, and to install the console 1 on the outside of the X-ray radiographing room R1 (in the X-ray control room R2). The communication between the cassette 5 and the radio repeater 6 can be well performed in the inside of the X-ray radiographing room R1 without being influenced by the X-ray shielding member enclosing the periphery of the X-ray radiographing room R1. On the other hand, the communication between the radio repeater 6 and the console 1 can be well performed on the inside and outside of the X-ray radiographing room R1.

Moreover, the radio repeater 6 is provided with the function of a charger of the cassette 5, and the function of a holder of the cassette 5 at the time of nonuse.

The radio repeater 6 is provided with a connector. When the connector is connected with the cassette 5, an internal power source 51 of the cassette 5 is charged. The radio repeater 6 is preferably formed to be easily attached or detached from the cassette 5. Moreover, the radio repeater 6 has the function as a holder of the cassette 5 at the time of nonuse besides the function of a charger of the cassette 5.

Incidentally, the console 1 is described to be installed in the X-ray control room R2 in the above, but the console 1 may be a portable terminal capable of wireless communication. In this case, it is preferable to install a radio repeater also in the X-ray control room R2 to enable the console communication section 14 to perform wireless communication with both of the radio repeater 6 in the X-ray radiographing room R1 and the radio repeater in the X-ray control room R2, so that communication can be performed with the cassette 5 in both of the X-ray radiographing room R1 and the X-ray control room R2. Consequently, a radiographer can instruct a radiography position and the like to a subject, not only in the X-ray control room R2 like the conventional way, but also in the X-ray radiographing room R1 while the radiographer confirms an X-ray image with the console 1 or starts the image processing of X-ray image data, and also the radiographer can confirm an X-ray image during a moving time between the X-ray radiographing room R1 and the X-ray control room R2 and can start the image processing of X-ray image data. Consequently, the total radiography efficiency of the whole X-ray radiography repeating a cycle of confirming an X-ray image from X-ray radiography can be improved.

A high-voltage generation source 41 to generate a high voltage and a X-ray tube 42 generating X rays when a high voltage is applied by the high-voltage generation source 41 are disposed in the X-ray source 4. An X-ray diaphragm apparatus (not shown) to adjust an X-ray radiating range is provided in an X-ray radiating opening of the X-ray tube 42. Because the X-ray diaphragm apparatus controls the X-ray radiating direction in conformity with a control signal from the console, an X-ray radiating range is adjusted according to a radiography area. Furthermore, an X-ray source control section 43 is disposed in the X-ray source 4, and the high-voltage generation source 41 and the X-ray tube 42 are severally connected to the X-ray source control section 43. The X-ray source control section 43 drives and controls each section of the X-ray source 4 on the basis of a control signal transmitted from the console communication section 14. That is, the X-ray source control section 43 controls the high-voltage generation source 41 and the X-ray tube 42.

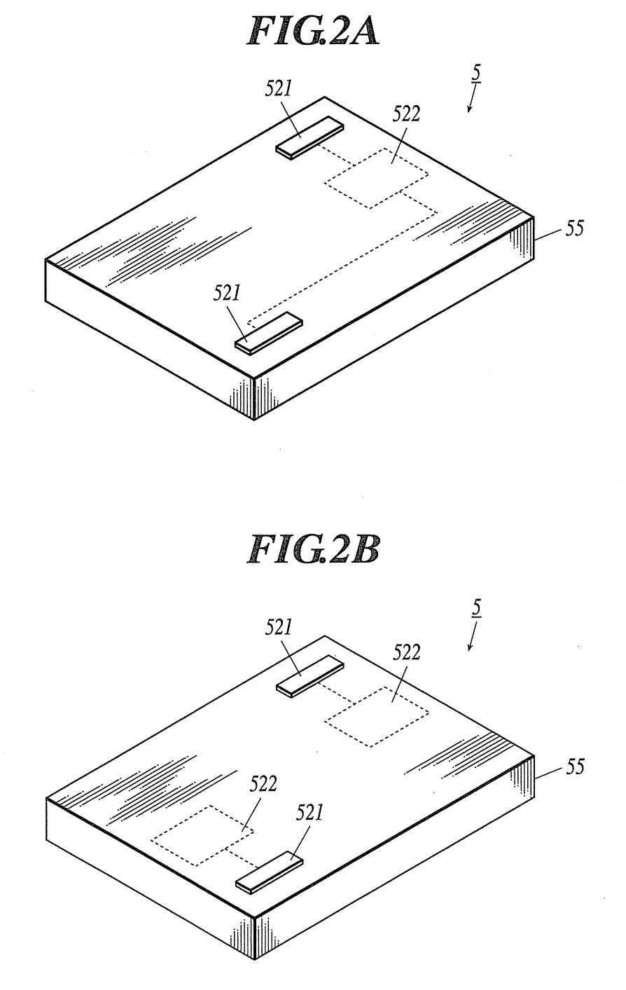

X rays that have output from the X-ray source 4 and transmitted the subject enter to the cassette 5. The cassette 5 is, as shown in FIG. 2, provided with a housing 55, and the inner part of the cassette 5 is protected by the housing 55. The housing 55 is made of a light metal, such as aluminum and magnesium. Because the housing 55 is made of the light metal, the intensity of the housing 55 can be held.

Moreover, an operator adjusts and arranges the positions and the directions of the cassette 5 and the subject before X-ray radiography in order to radiograph the X rays that have transmitted at a desired position and direction of the subject (also the position and the direction of the X-ray source 6 are adjusted and arranged according to circumstances). After that, the X-ray source 4 generates X rays by an instruction from the console 1. Then, the X rays that have output from the X-ray source 4 and transmitted the subject enter the cassette 5 in a desired position and a direction.

The internal power source 51, the cassette communication section 52, a cassette control section 53, and a panel 54 are disposed in the cassette 5. The internal power source 51, the cassette communication section 52, the cassette control section 53, and the panel 54 are severally connected to a bus in the cassette 5.

Moreover, the power source of the cassette 5 may be an external power source, such as a power source unit or an alternating-current power supply that are connected to the cassette 5 through an electric power line, which external power source supplies electric power from the outside, but the internal power source 51 installed in the cassette 5 is preferable owing to the easiness of management. Moreover, a power source unit provided so as to be circumscribed to the cassette 5 may be used as the internal power source 51 installed in the cassette 5, but it is preferable to use the internal power source 51 installed in the cassette 5.

If the cassette 5 includes the internal power source 51 supplying electric power, then it is preferable to include a plurality of power supply states different in the supplying state of electric power from one another, and to change the power supply states of the cassette 5 at suitable timings. As such supplying states of electric power, for example, it is preferable to include a radiography capable state and a state of consuming lower electric power than that of the radiography capable state. In particular, it is preferable to include one or a plurality of states under the control of radiography waiting mode, and the state under the control of sleep mode which state consumes further lower electric power, as the state consuming lower electric power that that of the radiography capable state.

Incidentally, a radiography operation means an operation necessary for acquiring radiation image data by radiation radiography. For example, in the case of the panel 54 shown in the embodiment, each operation of the initialization of the panel 54, the storage of electric energy generated by radiation radiating, reading of an electric signal, and formation of image data corresponds to the radiography operation.

Then, the radiography capable state means the state in which radiation image data can be immediately acquired by the radiography operation.

The internal power source 51 supplies electric power to each section disposed in the cassette 5. The internal power source 51 is provided with a capacitor capable of being charged and dealing with the electric power to be consumed at the time of radiography. As the capacitor, an electrolytic double layer capacitor can be applied. Moreover, as the internal power source 51, a primary battery, such as a manganese battery, a nickel-cadmium battery, a mercury battery, and a lead battery, which are necessary to be changed, and a chargeable secondary battery can be applied.

The capacity of the internal power source 51 is preferably four sheets or more (especially seven sheets or more) in terms of the number of sheets up to which the maximum size X-ray images can be continuously radiographed from the viewpoint of radiography efficiency.

Moreover, the capacity of the internal power source 51 is preferably 100 sheets or less (especially 50 sheets or less) in terms of the number of sheets up to which the maximum size X-ray images can be continuously radiographed from the viewpoint of miniaturizing, saving weight, and lowering the cost.

FIG. 2 is perspective views of the cassette 5 observed from the oblique direction of the back surface thereof reverse to the direction in which X rays are radiated. As shown in FIG. 2A, the cassette communication section 52 is composed of the plurality of antennas 521 and a communication circuit 522, and is configured so that the cassette communication section 52 can perform wireless communication with the radio repeater 6. The antennas 521 can receive an electric wave from the radio repeater 6, and can transmit an electric wave to the radio repeater 6. The communication circuit 522 demodulates a received electric wave signal from the radio repeater 6, which signal has been received by the antennas 521, and modulates and amplifies transmission data such as X-ray image data to output the data to the antennas 521. The antennas 521 are disposed to be close to the back surface of the housing 55 so as not to scatter X rays to exert bad influences on an X-ray image. Moreover, the antennas 521 may be disposed to be close to the outside than the outer periphery of the housing 55 so as not to scatter X rays to exert bad influences on an X-ray image.

The plurality of antennas 521 are provided at the positions different from each other on the outside of the housing 55 as shown in FIG. 2A. The one communication circuit 522 is provided in the inner part of the housing 55, and the plurality of antennas 521 is connected to the communication circuit 522 to enable each of the antennas 521 to perform the transmission and the reception of an electric wave.

Moreover, as shown in FIG. 2B, a plurality of communication circuits 522 may be provided in the inner part of the housing, and the antennas 521 may be connected to each of the communication circuits 522 correspondingly one by one. At this time, the frequencies of the electric waves that the communication circuits 522 can transmit and receive may be different from each other. In this case, each communication circuit may be configured to be able to generate and decode electric wave signals having different frequencies, or may be configured to be able to generate and decode electric wave signals having the same frequency.

The cassette control section 53 detects whether each of the antennas 521 can perform wireless communication with the radio repeater 6, and selects the antenna 521 performing the wireless communication with the radio repeater 6 among the antennas 521 capable of performing the wireless communication to drive and control the antenna 521 performing wireless communication and the communication circuit 522 corresponding to the antenna 521.

Moreover, as a modification, a plurality of communication circuits sharing one antenna, which communication circuits can generate and decode a plurality of electric wave signals having different frequencies, may be provided.

Moreover, the cassette control section 53 controls each section disposed in the cassette 5 on the basis of a control signal received by the cassette communication section 52.

The panel 54 outputs X-ray image data on the basis of the X rays that have transmitted the subject. Moreover, the panel 5 of the present embodiment is an indirect type flat panel detector (FPD).

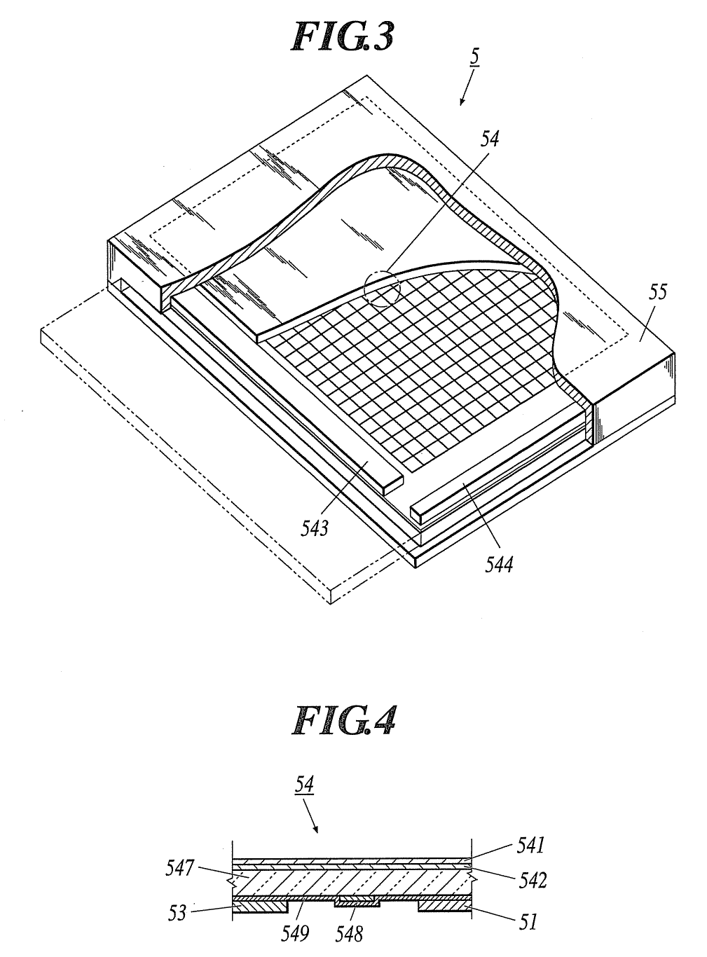

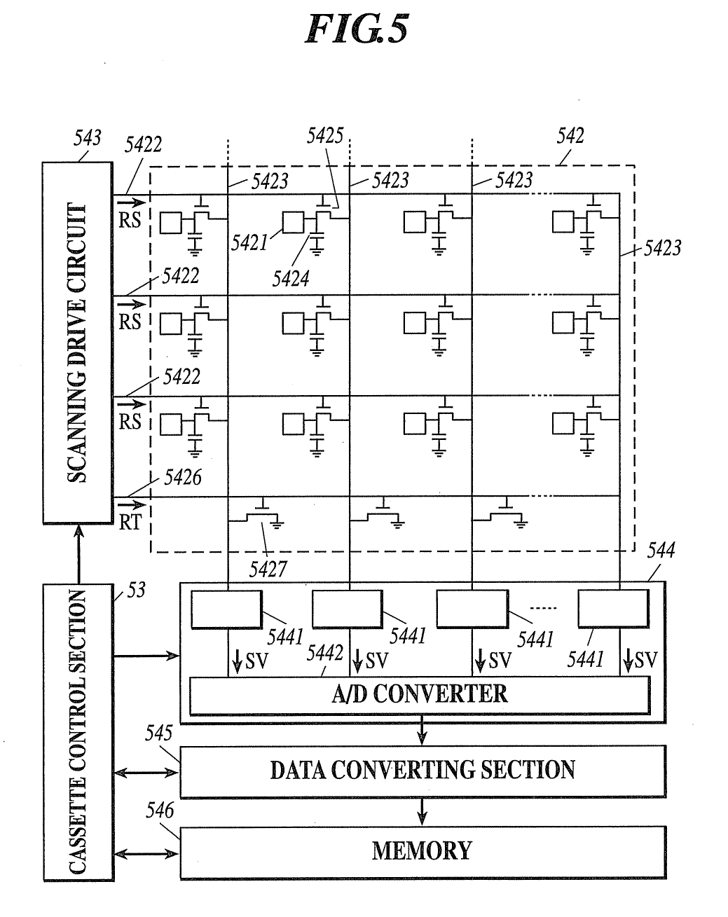

FIG. 3 shows a perspective view showing the schematic configuration of the cassette 5, and FIG. 4 is a sectional view of the cassette 5, where the panel 54 is centered.

Incidentally, although the example shown in FIGS. 3 and 4 is described in the present embodiment, the cassette 5 is not limited to the one shown in the figures, and the one having a different thickness and a kind of scintillator, and the one having a different area of the panel 54, which is the area of radiographing region, can be applicable. The thicker the thickness of the scintillator is, the higher the sensitivity becomes. The thinner the thickness of the scintillator is, the higher the spatial resolution becomes. Moreover, the spectral sensitivity of the scintillator differs according to the kind of the scintillator.

The panel 54 is provided with a scintillator 541 in a layer, which scintillator 541 detects the X rays that have transmitted a subject and converts the detected X rays into the fluorescence in a visible region (hereinafter referred to as “visible light”).

The scintillator 541 includes a fluorescent substance as the principal component thereof. The scintillator 541 is a layer in which the matrix material of the fluorescent substance is excited (absorption) by radiated X rays to emit a visible light by the recombination energy thereof. As the fluorescent substance, for example, the one emitting fluorescence by a matrix material such as CaWO₄ and CdWO₄, the one emitting fluorescence by a luminescent center material added into a matrix material such as CsI:Tl and ZnS:Ag, and the like can be cited.

A protection layer (not shown) may be formed on the upper layer of the scintillator 541. The protection layer protects the scintillator 541, and wholly covers the upper part and the rim of the scintillator 541. As the protection layer, any material may be used as long as it has the moisture-proof protection effect of the scintillator 541. Then, if a fluorescent substance having a hygroscopic property (especially an alkali halide and a columnar crystal fluorescent substance composed of an alkali halide) is used as the scintillator 541, then it is preferable to use a damp-proof organic film disclosed in, for example, U.S. Pat. No. 6,469,305, such as an organic film made from poly-para-xylylene formed by the chemical vapor deposition (CVD) method, an organic film formed of a polymer containing a silazane type polymer compound, such as polysilazane, or a siloxazane type polymer compound, such as polysiloxazane, an organic film formed by the plasma polymerization.

Photodetectors 542 formed of amorphous silicon are provided to be spread in a lamination on the lower layer of the scintillator 541, and visible lights emitted from the scintillator 541 is converted into electric energy to be output by the photodetectors 542.

Then, the panel 54 is preferably composed of 1,000×1,000 pixels (especially 2,000×2,000 pixels or more) from the viewpoint of the diagnosis property of a diagnosis by an X-ray image.

Moreover, the panel 54 is preferably composed of 10,000×10,000 pixels or less (especially 6,000×6,000 pixels or less) from the viewpoint of human sight limitation and the image processing speed of an X-ray image.

Moreover, the size of the radiography area of the panel 54 is preferable the area of 10 cm×10 cm or more (especially 20 cm×20 cm or more) from the viewpoint of the diagnosis property of a diagnosis of an X-ray image.

Moreover, the size of the radiography area of the panel 54 is preferably the area of 70 cm×70 cm or less (especially 50 cm×50 cm) from the viewpoint of the handleability as the cassette 5.

Moreover, the size of one pixel in the panel 54 is preferably the size of 40 μm×40 μm or more (especially 70 μm×70 μm or more) from the viewpoint of reducing an X-ray exposure dose.

Moreover, the size of one pixel in the panel 54 is preferably the size of 200 μm×200 μm or less (especially 160 μm×160 μm or less) from the viewpoint of the diagnosis property of a diagnosis on the basis of an X-ray image.

In the present embodiment, the panel 54 is composed of 4,096×3,072 pixels; the area of the radiography area thereof is 430 mm×320 mm; and the size of one pixel is 105 μm×105 μm.

Now, a circuit configuration laying stress on the photodetectors 542 is described.

As shown in FIG. 5, collecting electrodes 5421 for reading electric energy stored according to the intensities of radiated X rays are two-dimensionally arranged on the photodetectors 542. The collecting electrodes 5421 are made to be one-side electrodes of capacitors 5424, so that electric energy is stored in the capacitors 5424. One collecting electrode 5421 respectively corresponds to one pixel of the X-ray image data.

Scanning lines 5422 and signal lines 5423 are arranged between mutually adjacent collecting electrodes 5421. The scanning lines 5422 and the signal lines 5423 are perpendicular to each other.

Switching thin film transistors (TFT; hereinafter referred to as transistors) 5425 controlling the storage and the read of electric energy are connected to the capacitors 5424. The drain electrodes or the source electrodes of the transistors 5425 are connected to the collecting electrodes 5421, and the gate electrodes are connected to the scanning lines 5422. If the drain electrodes are connected to the scanning lines 5422, the source electrodes are connected to the signal lines 5423. If the source electrodes are connected to the collecting electrodes 5421, the drain electrodes are connected to the signal lines 5423. Moreover, in the panel 21, for example, initializing transistors 5427 to which the drain electrodes are connected are provided in the signal lines 5423. The source electrodes of the transistors 5427 are grounded. Moreover, the gate electrodes thereof are connected to a reset line 5426.

Incidentally, the transistors 5425 and the transistors 5427 are preferably formed as the silicon laminate structures or of organic semiconductors.

Moreover, the reset line 5426 to which a reset signal RT is transmitted from a scanning drive circuit 543 is connected to the scanning drive circuit 543 perpendicularly to the signal lines 5423.

The gate electrodes of the initializing transistors 5427, which are turned on by the reset signal RT, are connected to the reset line 5426. The gate electrodes of the initializing transistors 5427 are connected to the reset line 5426; their drain electrodes are connected to the signal lines 5423; and their source electrodes are grounded. If the source electrodes are connected to the signal lines 5423, the drain electrodes are grounded.

When the scanning drive circuit 543 supplies a reset signal RT to the initializing transistors 5427 through the reset line 5426 to turn the initializing transistors 5427 to their on-states and the scanning drive circuit 543 supplies a read signal RS to the transistors 5425 through the scanning lines 5422 to turn the transistors 5425 to their on-states, the electric energy stored in the capacitors 5424 is discharged to the outside of the photodetectors 542 through the transistors 5425. That is, the electric energy discharged from the photodetectors 542 is discharged to the ground electrode through the signal lines 5423 and the initializing transistors 5427. In the following, the discharges of the electric energy stored in the capacitors 5424 to the outside of the photodetectors 542 by the supply of the reset signal RT are referred to as the resets (initialization) of the photodetectors 542.

Moreover, the scanning drive circuit 543 supplying the read signals RS to the scanning lines 5422 are connected to the scanning lines 5422. The transistors 5425 connected to the scanning line 5422 to which the read signal RS is supplied becomes their on-states, and read the electric energy stored in the capacitors 5424 connected to the transistors 5425 to supply the read electric energy to the signal lines 5423. That is, the scanning drive circuit 543 can generate a signal of X-ray image data at each pixel by driving the transistors 5425.

A signal reading circuit 544 is connected to the signal lines 5423. The electric energy that has been stored in the capacitors 5424 and then has been read to the signal lines 5423 is supplied to the signal reading circuit 544. The signal reading circuit 544 is provided with signal converters 5441 supplying voltage signals SV in proportion to the electric energy quantities supplied to the signal reading circuit 544 to an A/D converter 5442, and the A/D converter 5442 converting the voltage signals SV from the signal converters 5441 into digital signals to supply the digital signals to a data converting section 545.

The data converting section 545 is connected to the signal reading circuit 544. The data converting section 545 generates X-ray image data on the basis of the digital signals supplied from the signal reading circuit 544.

When image data having high resolution is not needed, and when image data is desired to be acquired quickly, the console control section 13 transmits received control signals of thinning out, pixel averaging, region extracting, and the like to the cassette control section 53 according to the radiography method selected by an operator. The cassette control section 53 performs control to execute the following thinning out, pixel averaging, region extracting, and the like according to the received control signals of thinning out, pixel averaging, region extracting, and the like.

The thinning out is performed by thinning out the number of pixels to be read to a quarter of the whole number of the pixels by reading only odd number columns or even number columns, or is performed by similarly thinning out to a ninth, a sixteenth, and the like. Incidentally, the method of thinning out is not limited to this method.

Moreover, the pixel averaging can be calculated by driving a plurality of scanning lines 5422 at the same time, and by performing analog addition of two pixels in the same column direction. The pixel averaging is not limited to the calculation of the addition of two pixels, but can be easily acquired by performing analog addition of a plurality of pixels in a column signal wiring direction. Furthermore, as to the addition in a row direction, an addition value in a regular square of 2×2 or the like can be acquired by performing digital addition of adjacent pixels after A/D conversion output in addition to the analog addition mentioned above. By these methods, high speed data reading can be performed without wasting radiated X rays.

Moreover, the region extracting has means for limiting the capturing region of image data. The means is to specify a necessary acquiring region of image data on the basis of an instruction content of a radiography method and the like, to change the data capturing range of the scanning drive circuit 543 on the basis of the specified acquiring region with the cassette control section 53, and to drive the changed capturing range with the panel 54.

A memory 546 is connected to the data converting section 545. The memory 546 stores the X-ray image data generated by the data converting section 545. Moreover, gain correcting data is stored in the memory 546 in advance.

The memory 546 is composed of a random access memory (RAM) and a nonvolatile memory. The memory 546 enables to sequentially write the X-ray image data that has been sequentially generated by the data converting section 545 into the RAM before writing the X-ray image data into the nonvolatile memory in a lump. The nonvolatile memory is composed of two or more memory parts such as an electrically erasable programmable read-only memory (EEPROM), a flash memory, and the like, and writing data to one of the memory parts wile the other of them is being erased.

As described above, because the cassette 5 is provided with the memory 546 to temporarily store X-ray image data, the acquired X-ray image data can be temporarily store in the memory 546, and it is not necessary to delay the X-ray radiography until communication condition becomes good even in the case of a communication poor condition or being in a communication impossible condition. The X-ray image data stored in the memory 546 can be transmitted from the cassette 5 to the console 1 at a communication speed according to the communication condition between the cassette 5 and the console 1. Incidentally, the capacity of the memory 546 is preferably four or more (especially 10 or more) in terms of the storable number of images of the maximum data size from the viewpoint of the efficiency of radiography. Moreover, the capacity of the memory 546 is preferably 1,000 or less (especially 100 or less) in terms of the storable number of images of the maximum data size from the viewpoint of lowering the cost.

A flat plate-shaped supporting body 547 composed of a glass board is provided on the lower side of the photodetectors 542, and the laminated structure of the scintillator 541 and the photodetectors 542 is supported by the supporting body 547.

Incidentally, as the laminated structure, the configuration in which the scintillator 541 is wholly covered by the protection layer at the upper part and the rim thereof and by the supporting body 547 at the lower part thereof is preferable. In this case, the steam in the air is intercepted by the protection layer and the supporting body 547, and the deterioration of the scintillator 541 owing to moisture can be suppressed.

An X-ray dose sensor 548 is provided on the under surface of the supporting body 547 (that is, on the surface of the supporting body 547 on the opposite side to the X-ray radiating direction). The X-ray dose sensor 548 detects the dose of the X-ray that has transmitted the photodetectors 542. When the X-ray dose reaches a predetermined quantity, the X-ray dose sensor 548 transmits a predetermined X-ray dose signal to the cassette control section 53. Moreover, in the present embodiment, an amorphous silicon light receiving element is used as the X-ray dose sensor 548. But, the X-ray dose sensor is not limited to that one. An X-ray sensor using a light receiving element made of crystalline silicon or the like to directly detect X rays, and a sensor using scintillator to detect fluorescence may be used.

An X-ray shielding member 549 is provided on the under surfaces of the supporting body 547 and the X-ray dose sensor 548 (that is, the surfaces of the supporting body 547 and the X-ray dose sensor on the opposite side of the X-ray radiating direction). Lead is used for the X-ray shielding member 549. Radiated X rays are absorbed by the X-ray shielding member 549, and do not transmit the X-ray shielding member 549. The internal power source 51 and the cassette control section 53 are provided on the under surface of the X-ray shielding member 549. Because X rays are absorbed by the X-ray shielding member 549, it does not occur that X rays are scattered by the internal power source 51 and the cassette control section 53 to be reflected to the panel 54. Consequently, the panel 54 can acquire good image data.

As described above, the cassette 5 is driven by the electric power from the internal power source 51, and is portable and cable-less. Furthermore, the cassette communication section 52 and the console communication section 14 communicate with each other through wireless communication. Consequently, the cassette 5 keeps the co-movement with the console 1, and has good operationality. Then, the radiography efficiency can be improved.

Incidentally, although the example of the panel 54 composed of one panel including 4,096×3,072 pixels has been shown in the present embodiment, the panel 54 is not limited to this one. For example, a panel 54 composed of four small panels each including 2,048×1,536 pixels may be used. In such a case of the panel 54 composed of a plurality of small panels, the trouble of combining four small panels to form one panel 54 is produced. But, because the yield of each panel 54 is improved, the yield of the whole panel is also improved, and there is the advantage of lowering the cost.

Furthermore, although the example of reading the electric energy of radiated X rays using the scintillator 541 and the photodetectors 542 in the present embodiment, the method is not limited to this one, and it is possible to apply a photodetector capable of converting X rays into electric energy directly. For example, an X-ray detector composed of an X-ray electric energy converting section using amorphous Se, PbI₂, or the like, amorphous silicon TFTs, and the like, may be used.

Moreover, although the example of providing one A/D converter 5442 in the signal reading circuit 544 has been shown in the present embodiment, the present invention is not limited to this configuration, and a plurality of A/D converters can be applied.

Then, the number of the A/D converters is preferably four or more, especially eight or more, in order to shorten an image reading time and to acquire a desired S/N ratio.

Moreover, the number of the A/D converters is preferably 64 or less, especially 32 or less, in order to lowering the cost and miniaturizing. Thereby, the analog signal band and the A/D conversion rate are not made to be unnecessary large.

Moreover, although the example of the supporting body 547 formed of glass has been shown in the present embodiment, the supporting body is not limited to this one, but a supporting body formed of a resin, a metal, or the like, can be applied.

Incidentally, it is described in the above that the console 1 is installed in the X-ray control room R2, but the console 1 may be a portable terminal capable of performing wireless communication. In this case, it is preferable to install a radio repeater also in the X-ray control room R2 to enable the console communication section 14 to perform wireless communication with both of the radio repeater 6 in the X-ray radiographing room R1 and the radio repeater in the X-ray control room R2, and to make it possible to perform communication with the cassette 5 in both of the X-ray radiographing room R1 and the X-ray control room R2 as the result. Thereby, a radiographer can instruct the radiographer about a radiography position and the like not only in the X-ray control room R2 like the prior art but also in the X-ray radiographing room R1 while the radiographer confirms an X-ray image with the console 1 and starts the image processing of X-ray image data. Moreover, the radiographer can confirm an X-ray image and can start the image processing of X-ray image data during a moving time between the X-ray radiographing room R1 and the X-ray control room R2. The total radiography efficiency of the whole X-ray radiography repeating a cycle of from X-ray radiography to the confirming of X-ray image can be improved.

Next, the operation of the X-ray image acquisition system according to the first embodiment of the present invention is described.

The cassette control section 53 controls the scanning drive circuit 543 to be kept in the off-state thereof until the cassette control section 53 receives a radiography preparation instruction signal from the console control section 13. In order to keep the scanning drive circuit 543 in the off-state thereof, the cassette control section 53 sets the electric potential of the scanning lines 5422, the signal lines 5423, and the reset line 5426 at the same potential, and controls the scanning drive circuit 543 not to apply any bias to the collecting electrodes 5421. Moreover, the cassette control section 53 may keep the power source of the signal reading circuit 544 in the off-state thereof, and may set the electric potential of the scanning lines 5422, the signal lines 5423, and the reset line 5426 at the GND potential.

The states of the scanning drive circuit 543 and the signal reading circuit 544 in which no bias is applied to them includes a radiography waiting mode and a sleep mode.

Incidentally, in the radiography waiting mode, it is preferable not to apply the bias potential to the photodiodes, but also not to supply electric power to the scanning drive circuit 543 and the signal reading circuit 544 because the scanning drive circuit 543 and the signal reading circuit 544 rise quickly, which enables the further suppression of power consumption. Furthermore, because no signals are generated in the radiography waiting mode, it is preferable not to supply electric power also to the data converting section 545, which enables the further suppression of power consumption.

Moreover, it is preferable to provide the sleep mode consuming less electric power than the radiography waiting mode. Then, it is preferable to shift to the sleep mode after a radiographed image has been completely transmitted to the console 1. Then, in the sleep mode, it is preferable to stop the supply of electric power to the high speed transmission function of the cassette communication section 52 or the whole transmission function thereof and memories, remaining the functions necessary for rising to radiography waiting mode by an instruction from the console 1. That is, in the sleep mode, it is preferable not to apply any bias voltage to the photodiodes, and not to supply electric power to the scanning drive circuit 543, the signal reading circuit 544, the data converting section 545, the memory 546, and the high speed transmission functions or the whole transmission function of the cassette communication section 52. Thereby, waste electric power consumption can be more suppressed.

As described above, because in the radiography waiting mode and the state under the control of the sleep mode, in which consumption power per unit time is lower than that in the radiography capable state, the electric potential of the scanning lines 5422, the signal lines 5423, and the reset line 5426 is made to be the same potential to be in the state in which no bias is applied to the collecting electrodes 5421, that is, in the sate in which no voltage is substantially applied to a plurality of pixels, it is possible to suppress the deterioration owing to the substantial application of voltages to the PDs and the TFTs, that is, the deterioration of a plurality of pixels can be suppressed. Moreover, waste consumption of electric power can be also suppressed.

Then, when the input section 12 receives an instruction content for radiography, such as the turning on of the first switch of the X-ray radiating switch and the input of predetermined items, such as subject information and radiography information, through the operation inputting section 2, or when the input section 12 receives order information from the HIS/RIS 71, the console control section 13 determines radiography conditions on the basis of the instruction content of the operator and the order information from the HIS/RIS 71 or the like, and transmits a radiography preparation instruction signal based on the radiography conditions to the X-ray source control section 43 and the cassette control section 53 through the console communication section 14 to shift the states of the X-ray source 4 and the cassette 5 to the radiography capable state.

When the X-ray source control section 43 receives the radiography preparation instruction signal, the X-ray source control section 43 drives and controls the high-voltage generation source 41 to allow the high-voltage generation source 41 to shift to the state of applying a high voltage to the X-ray tube 42.

When the cassette control section 53 receives the radiography preparation instruction signal, the cassette control section 53 shifts to the radiography capable state. That is, the reset of all the pixels is repeated at a predetermined interval until a radiography instruction is input in the radiography capable state to prevent the storage of electric energy into the capacitors 5424 by dark currents. Because the continuing time of the radiography capable state is unknown, the predetermined interval is longer than the time of radiography, and the on-times of the transistors 5425 are set to be shorter than the time of radiography. Consequently, reading operations, which loads the transistors 5425, becomes less in the radiography capable state. Then, after the shift to the radiography capable state, the cassette control section 53 transmits a radiography capable state shift signal to the console 1. When the console control section 13 receives the radiography capable state shift signal, the console control section 13 controls the display control section 11 to allow the display section 3 to display a cassette radiography capable state display showing the shift of the cassette to the radiography capable state.

When a radiography instruction is input into the console control section 13, the console control section 13 determines radiography conditions on the basis of an instruction content of an operator and order information from the HIS/RIS 71 or the like, and transmits the radiography condition information pertaining to the radiography conditions to the X-ray source control section 43 and the cassette control section 53 through the console communication section 14.

When the console control section 13 receives an X-ray radiating instruction, such as the turning on of the second switch of the X-ray radiating switch, from the operator, the console control section 13 transmits the radiography instructing signal to the cassette control section 53 of the cassette 5. Then, after the X-ray radiating instruction has been input into the console control section 13, the console control section 13 controls the X-ray source 4 and the cassette 5 to perform radiography, synchronizing them.

When the cassette control section 53 receives the radiography instructing signal, the cassette control section 53 initializes the panel 54 to shift the panel 54 to the state capable of storing electric energy. To put it concretely, the cassette control section 53 performs refreshing, and performs a predetermined times of resets of the whole pixel dedicated for a radiography sequence and a reset of the whole pixel dedicated for an electric energy storing state so as to transit to an electric energy storing state. Because the predetermined time is practically required to be short in a period of from an exposure request to the radiography preparation completion, the resets of the whole pixels dedicated for the radiography sequence is performed. Furthermore, in the case that an exposure request occurs from any driving state of radiography capable state, the cassette control section 53 immediately enter a radiography sequence drive, and thereby makes the period of from the exposure request to the radiography preparation completion short so as to achieve the improvement of operationality.

When the panel 54 has shifted to the state capable of storing electric energy, the cassette control section 53 transmits a preparation end signal of the cassette 5 to the console communication section 14. When the console communication section 14 receives the preparation end signal, the console communication section 14 transmits the preparation end signal of the cassette to the console control section 13.

When the console control section 13 is in the state of receiving the preparation end signal of the cassette and enters the state of receiving an X-ray radiating instruction, the console control section 13 transmits an X-ray radiating signal to the X-ray source 4. When the X-ray source control section 43 receives the X-ray radiating signal, the X-ray source control section 43 drives and controls the high-voltage generation source 41 to apply a high voltage to the X-ray tube 42 to generate X rays from the X-ray source 4. The X-ray radiating range of the X rays generated by the X-ray source 4 are adjusted by the X-ray diaphragm apparatus provided in the X-ray radiating opening, and the X rays irradiate the subject.

Moreover, the console control section 13 controls the display control section 11 to allow the display section 3 to display an X-ray radiographing display showing being in X-ray radiography.

The X rays that have transmitted the subject enter the cassette 5. The X rays that have entered the cassette 5 is converted by the scintillator 541 into a visible light.

The X-ray dose sensor 548 detects the dose of the X rays that has irradiated the cassette 5. Then, the detected X-ray dose is detected by the X-ray dose sensor 548. When the X-ray radiation quantity reaches a predetermined quantity, the X-ray dose sensor 548 transmits a predetermined X-ray dose signal to the cassette control section 53. When the cassette control section 53 receives the predetermined X-ray dose signal, the cassette control section 53 transmits an X-ray ending signal to the console communication section 14 through the radio repeater 6. When the console communication section 14 receives the X-ray ending signal, the console communication section 14 transmits the X-ray ending signal to the console control section 13, and transmits an X-ray radiation ending signal to the X-ray source control section 43. When the X-ray source control section 43 receives the X-ray radiation ending signal, the X-ray source control section 43 drives and controls the high-voltage generation source 41 to stop the high-voltage generation source 41 from applying a high voltage to the X-ray tube 42. Thereby, the generation of the X rays is stopped.

When the cassette control section 53 has transmitted the X-ray ending signal, the cassette control section 53 drives and controls the scanning drive circuit 543 and the signal reading circuit 544 on the basis of the X-ray ending signal. The scanning drive circuit 543 reads the electric energy acquired by the photodetectors 542, and inputs the acquired electric energy into the signal reading circuit 544. The reading of the electric energy acquired by the photodetectors 542 may be set to be performed, for example, after a predetermined time from the start or the end of the transmission of the X-ray ending signal, or may be set to be performed at the same time as the end of the transmission. The signal reading circuit 544 converts the input electric energy into a digital signal. Then, the data converting section 545 configures the digital signal to image data. The memory 546 temporarily stores the image data configured by the data converting section 545.

Successively, the cassette control section 53 acquires correcting image data after acquiring the image data. The correcting image data is dark image data without performing X-ray radiation, and is used for the correction of an X-ray image for acquiring a high quality X-ray image. The acquiring method of the correcting image data is the same as the acquiring method of image data except for not radiating X rays. An electric energy storing time is set to be equal at both the times of acquiring the image data and of acquiring the correcting image data. The electric energy storing time means the time from the completion of a reset operation, that is, the turning-off of the transistors 5425 at the rest time, to the next turning-on of the transistors 5425 for performing the reading of electric energy. Consequently, the timing of starting the storage of electric energy and the electric energy storing time differ according to each of the scanning lines 5422.

The data converting section 545 performs the offset correction of the configured image data on the basis of the acquired correcting image data, and successively performs the gain correction of the image data on the basis of the gain correcting data that has been previously acquired and stored in the memory 546. Then, the image is continuously interpolated lest the sense of discomfort should arise at joining parts of small panels and the like in the case of the panel 54 including dead pixels and a plurality of small panels, and the correction processing pertaining to the panel 54 is completed. In the present embodiment, the data converting section 545 is formed as a separated body from the cassette control section 53, but the cassette control section 53 may also function as the data converting section 545.

Then, after a predetermined time has elapsed from the end of radiography, the cassette control section 53 performs the communication of the X-ray image data stored in the memory 546 using an electric wave having a frequency exceeding 1 GHz from the plurality of antennas 521 of the cassette communication section 52.

When the console control section 13 receives the X-ray image data from the antennas 521 through the radio repeater 6 and the console communication section 14, the console control section 13 transmits the X-ray image data to the image storage section 16, and the image storage section 16 temporarily stores the X-ray image data. Because the radio repeater 6 and the console communication section 14 are connected with each other with the communication cable, the image data is transferred from the radio repeater 6 to the console communication section 14 at a high speed.

Moreover, it is preferable to encode X-ray image data to transmit it when the X-ray image data is transmitted by wireless transmission. That is, it is preferable to provide to the cassette 5 encoding means for encoding X-ray image data to be transmitted, and to provide to console 1 code decoding means for decoding encoded X-ray image data. The cassette control section 53 or the cassette communication section 52 may function also as such encoding means, or an encoding section may be provided separately from those sections 53 and 52. Moreover, the radio repeater 6, the console communication section 14, or the console control section 13 may also function as such code decoding means, or a decoding section may be provided separately from those repeater 6 and sections 14 and 13.

Then, as a technique fitted to such encoding, for example, Wired Equivalent Privacy (WEP) defined in IEEE 802.11 (encoding using a common key having a key length of 64 bits or 128 bits), Temporal Key Integrity Protocol (TKIP) defined by IEEE 802.11i (encoding performing encoding while automatically changing the key), Wi-Fi Protected Access (WPA) (encoding using both of the TKIP and the IEEE 802.1x), and Advanced Encryption Standard (AES) defined in IEEE 802.11i, and the like, can be cited, but the encoding method is not limited to those ones.

Moreover, it is preferable to limit the access of the other equipment to the cassette communication section 52, the console communication section 14, and the radio repeater 6. As such an access limiting function, the following functions can be cited: for example, a service set identifier (SSID) (the ID peculiar to an equipment to be connected, which ID is for neglecting a packet having a not-coinciding SSID included in the header of the packet), a media access control (MAC) address (address peculiar to a LAN card) filtering function (for allowing connection only to the terminals having registered MAC addresses), an ANY connection rejecting function (the function to be set to an access point for rejecting connection to the access point when the SSID setting of a client is “ANY.” The function is the exceptional one to the fact that the SSID setting of a client being “ANY” can be generally connected to all access points having an SSID.), a function without any SSID in a beacon signal, and the user authentication by an authentication (RADIUS) server defined in IEEE 802.1x (rejecting all communications from not-authenticated terminals, and allowing only authenticated users to perform communication), but the access limiting function is not limited to those ones.

Moreover, it is preferable to compress X-ray image data in the cassette 5 and to decode the compressed data on the side of the console 1 in order to improve a communication speed. That is, it is preferable to provide compressing means for compressing X-ray image data to be transmitted in the cassette 5, and to provide compression decoding means for decoding the compressed X-ray image data in the console 1. The cassette control section 53 or the cassette communication section 52 may also function as such compressing means, or a compressing section may be provided separately from those ones. Moreover, the radio repeater 6, the console communication section 14, or the console control section 13 may also function as such compression decoding means, or a compression decoding section may be provided separately from those ones.

If encoding is performed in this case, then it is preferable to perform encoding processing after compressing processing, and to perform decoding processing of compressed data after decoding processing of encoded data. That is, it is preferable to encode the X-ray image data compressed by the compressing means with encoding means, and to perform the compression decoding of the X-ray image data to which the code decoding has been performed by the code decoding means with compression decoding means.

Then, when the console control section 13 receives X-ray image data, the console control section 13 temporarily stores the X-ray image data into the image storage section 16. Then, the console control section 13 controls the image processing section 15 to generate thumbnail image data from the X-ray image data that has been temporarily stored in the image storage section 16. The display control section 11 controls the display section 3 to display a thumbnail image on the basis of the generated thumbnail image data.

After that, the image processing section 15 performs the image processing of image data on the basis of an instruction content of an operator and the order information from the HIS/RIS 71 or the like. The image data that has received the image processing is displayed as an image on the display section 3, and at the same time is transmitted to the image storage section 16 to be stored as image data. Furthermore, the image processing section 15 performs the re-image processing of image data on the basis of an instruction of the operator, and the display section 3 displays the image processing result of the image data. Moreover, the network communication section 18 transfers the image data to the imager 72, the image processing terminal 73, the viewer 74, the file server 75, and the like, which are the external apparatus on the network. When image data is transferred from the console 1, an external apparatus that has received the transfer correspondingly functions. That is, the imager 72 records the X-ray image data in an image recording medium, such as a film. The image processing terminal 73 performs the image processing of the X-ray image data and the processing for a computer aided diagnosis (CAD), and stores the processed data into the file server 75. The viewer 74 displays an X-ray image on the basis of the X-ray image data. The file server 75 stores the X-ray image data.

Next, the selection of an antenna to be used for wireless communication by the cassette communication section of the first embodiment of the present invention is described.

The cassette control section 53 detects whether each of the antennas 521 can perform wireless communication with the radio repeater 6. When the cassette control section 53 detects an antenna 521 that cannot perform the wireless communication, controls the radio repeater 6 to perform the wireless communication with an antenna 521 that can perform the wireless communication.

Moreover, if the cassette control section 53 detects that a plurality of antennas 521 can perform the wireless communication with the radio repeater 6, then the cassette control section 53 may control the radio repeater 6 to perform the wireless communication with an antenna 521 that can perform communication at a higher speed among the antennas 521, or may control the radio repeater 6 to perform the wireless communication by using all of the antennas.

Moreover, the cassette control section 53 may perform communication using all antennas without detecting whether each of the antennas 521 can perform wireless communication with the radio repeater 6.

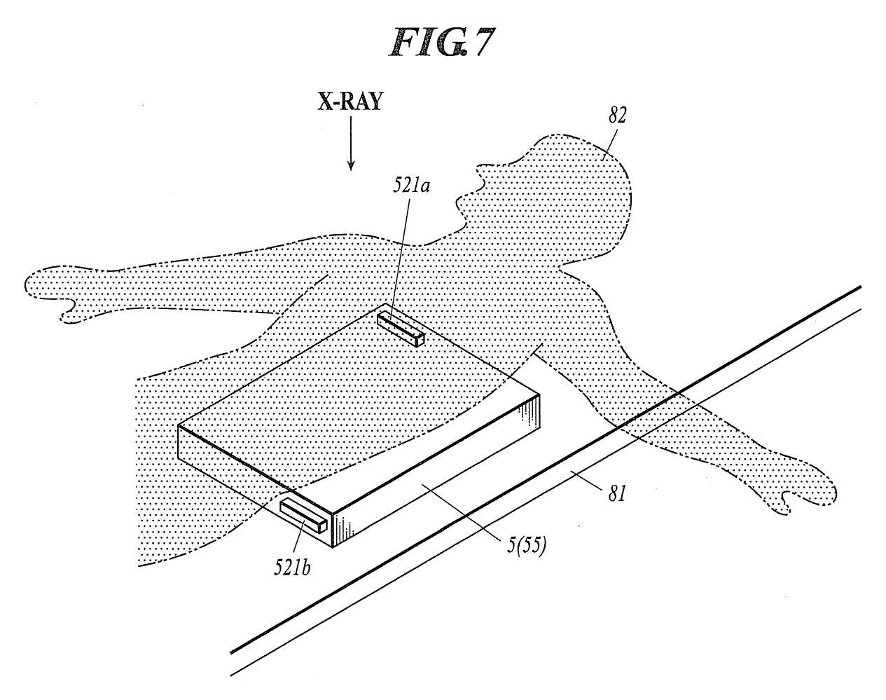

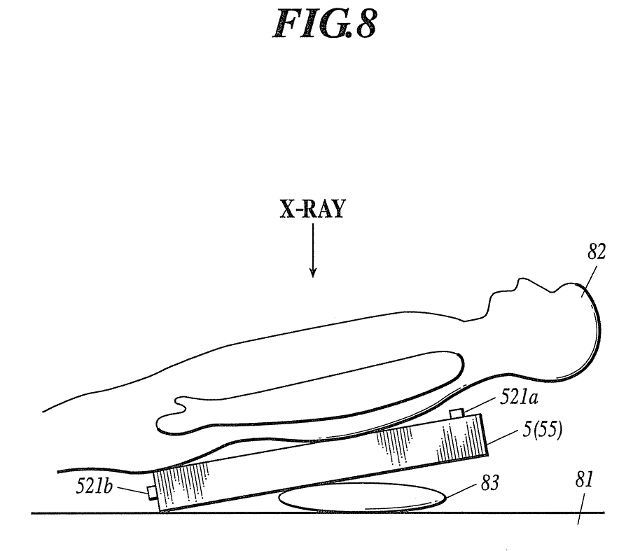

Next, the positional relation between the cassette 5 of the first embodiment of the present invention and a patient who is a subject is described with reference to FIGS. 7 and 8.

As one of the positional relation generally used in X-ray radiography, for example, as shown in FIG. 7, there is an arrangement in which the cassette 5 is disposed on the upper surface of a radiographing bed 81 with a patient 82, who is the subject, laid on the cassette 5, and X rays are radiated from the above of the patient 82. A radiographing bed 81 made of a metal having a property of reflecting electric waves or the one made of a wood having a property of absorbing electric waves is sometimes used. If the patient 82 is laid on such a radiographing bed 81, for example, as shown in FIG. 7, it is possible to perform electric wave communication with the antenna 521b if the antenna 521b is not covered by the patient 82, even if the antenna 521a is covered by the patient 82.

Moreover, as shown in FIG. 8, it is also possible to perform the following arrangement: a placing stand 83 is placed on the upper surface of the radiographing bed 81, and the cassette 5 is arranged so that one end of the cassette 5 is placed on one end of the radiographing bed 81 with the other end of the cassette 5 placed on the placing stand 83. Then, the patient 82, who is the subject, is made to lean on the cassette 5, and X rays are radiated from the above of the patient 82. In this case, the radiographing bed 81 made of a metal having the property of reflecting electric waves or the one made of a wood having the property of absorbing electric waves is used. For example, as shown in FIG. 8, even if the antenna 521b is covered by the patient 82 and the radiographing bed 81 and it is impossible to perform electric wave communication, antenna 521a can perform electric wave communication through the space formed by the placing stand 83.

As described above, because the plurality of antennas 521 is provided to the cassette 5 of the first embodiment, even if an antenna 521 that cannot communicate with the radio repeater 6 exists, wireless communication can be performed with another antenna 521 capable of communicating with the radio repeater 6. Moreover, if the antenna 521 that can communicate with radio repeater 6 exists and the antenna 521 is the one capable of performing transmission and reception by a microwave, the image data having a large capacity can be transmitted at a high speed by performing wireless communication using the antenna 521 that can perform transmission and reception by the microwave. That is, because the panel 54 of the cassette 5 acquires X-ray image data by X-ray radiography and the acquired radiation image data is transmitted by an electric wave having a frequency exceeding 1 GHz from the antennas 521 located at a plurality of different positions of the cassette communication section 52, the X-ray image data can be transmitted at a high speed, and even if the position of one antenna is the one where the multi pass fading or the shadowing arises, it is rare that the positions of both of the antennas are the ones where the multi pass fading or the shadowing arises. Consequently, the occurrence of the situation in which X-ray image data cannot be transmitted owing to a communication impossible condition or a communication poor condition can be lessened.

Moreover, because the cassette communication section 52 can transmit or receive a radiographing signal for acquiring X-ray image data by X-ray radiography from the antennas 521 located at the plurality of different positions on the cassette communication section 52, the cassette communication section 52 can transmit or receive the radiographing signal surely and timely.

Moreover, the cassette communication section 52 includes the housing 55, which is made of an electroconductive material and encloses the panel 54, and the plurality of antennas 521 is provided to be close to the housing 55. Consequently, the plurality of antennas 521 does not disturb X-ray radiography, and, although strong directivity arises owing to the housing 55 made of the electroconductive material, communication can be surely and timely performed because the plurality of antennas are provided.

Moreover, because the case where the multi pass fading arises in both the electric waves is further rare even if the multi pass fading arises in one electric wave, the occurrence of the situation in which X-ray image data cannot be transmitted owing to a communication impossible condition or a communication poor condition can be further lessened by using a plurality of electric waves having mutually different frequencies.

Moreover, the first antenna 521a and the second antenna 521b share the communication circuit 522, and consequently it is possible to perform transmission and reception surely and timely with the cost lowered and the size miniaturized.

Moreover, the memory 546, which temporarily stores the X-ray image data acquired from the panel 54, is provided, and consequently it is not necessary to delay X-ray radiography until the communication condition becomes good even if a communication poor condition or a communication impossible condition exists, and it is possible to temporarily store X-ray image data into the memory 546 and to transmit the X-ray image data stored in the memory 546 at a communication speed according to the communication condition.

Moreover, the cassette 5 is provided with the power source 51 supplying electric power to the communication circuit 522 of the plurality of antennas 521 and the panel 54, and consequently X-ray radiography can be performed in the cable-less state in which no cables are used between the other apparatus. Then, it is unnecessary to perform X-ray radiography with attention paid not to twine the cable around a subject, which realizes good operationality and can improve radiography efficiency.

Moreover, the X-ray detector 542 receiving X rays and outputting an electric signal, the data converting section 544 acquiring X-ray image data from the electric signal output from the X-ray detector 542, and the X-ray shielding member 549 arranged on the opposite side of the X-ray detector 542 to the side thereof on which X rays are radiated to absorb the X rays are provided. Although the X-ray intercepting member 549 causing the directivity of wireless communication is provided, communication can be surely and timely performed because the plurality of antennas 521 are provided.

Moreover, the circuit including the data converting section 544 and the communication circuit 522 of the plurality of antennas 521, and the power source 51 are provided on the side of the X-ray shielding member 549 opposite to the one irradiated with X rays. Thereby, the dose of the X rays entering the circuit and the power source 51 is suppressed, and the quantity of the X rays scattered by the circuit and the power source 51 and entering the X-ray detector 542 is further suppressed by the X-ray shielding member 549. Consequently, good X-ray image data can be acquired.

Moreover, at least one of the antennas 521 transmitting X-ray image data is selected among the plurality of antennas 521, and the X-ray image data is transmitted. Consequently, even if one antenna 521 is in a communication impossible condition or in a communication poor condition, X-ray image data can be transmitted by selecting another antenna 521.

Moreover, the cassette 5 and the console 1 receiving the X-ray image data transmitted from the cassette 5 through the radio repeater 6 receiving the electric wave transmitted from the cassette 5 are provided, and consequently the occurrence of the situation in which X-ray image data cannot be transmitted owing to a communication impossible condition or a communication poor condition is little. Consequently, an X-ray image can be efficiently and stably acquired.

The radio repeater 6 detects the communication condition of wireless communication, and, if the communication condition of the wireless communication detected by the radio repeater 6 is in a communication impossible condition, the console 1 allows the display section 3 to display the communication impossible condition. Consequently, an operator can directly cope with the situation by adjusting the position of the cassette 5 or the subject or by the similar means.

Moreover, the radio repeater 6 detects the communication condition of wireless communication, and, if the communication condition of the wireless communication detected by the radio repeater 6 is a communication poor condition, the console allows the display section 3 to display the communication poor condition. Consequently, the operator can directly cope with the situation by adjusting the position of the cassette or the subject or by the similar means.

Incidentally, in the present embodiment, while the cassette 5 performs the wireless transmission trough a predetermined cannel, in order to prevent radio interference caused by the wireless transmission of another equipment through this predetermined cannel, the console control section 13 changes the channel of the cassette 5 when possible, or changes the channel of the other equipment when possible, if the channel of the other equipment and the channel used by the cassette 5 coincide with each other. However, if the change of each channel is impossible, the console control section 13 controls the display control section 11 to allow the display section 3 to perform a warning display warning not to use the other equipment at the time of transmitting radiation image data, or the like.

Moreover, as a modification, a configuration can be cited in which the console control section 13 does not perform the control to prevent radio interference by the wireless transmission of the other equipment through the predetermined cannel at the time of the wireless transmission of the cassette 5 though this predetermined channel. For example, the case where it is appear that the other equipment does not perform the wireless transmission through the predetermined channel while the cassette 5 performs wireless transmission through this predetermined channel, the case where the cost for providing such control is desired to be reduced, and the like are applied.

As described above, the cassette control section 53 performs the control of changing the power supply states of the cassette 5 at suitable timings like the radiography capable state, one or a plurality of states under the control of radiography waiting mode in which power consumption is lower than that of the radiography capable state, and the state under the control of sleep mode in which power consumption is further lower. Then, the cassette control section 53 controls the cassette communication section 52 to transmit power supplying state information indicating the power supply state of the cassette 5 in time to the timing of performing the control of changing the power supply state of the cassette 5.

Because the console control section 13 performs control using power supplying state information indicating the power supply state of the cassette 5, which information has been received by the console communication section 14, good radiography can be controlled, and radiography efficiency can be improved. Moreover, because the console control section 13 allows the display section 3 to display according to the power supplying state information, an operator can judge whether the cassette 5 can immediately perform X-ray radiography, and the operator can improve the radiography efficiency, for example, by changing the order of the radiography using another cassette 5 and the radiography of modality.

Moreover, in the present embodiment, the example in which the cassette 5 and the console 1 correspond to each other one by one is shown, the arrangement of them are not limited to this one. It is possible to use the cassettes and consoles corresponding to one another at the rates of: one by M, N by one, and N by M (where N and M are natural number of 2 or more). In this case, it is preferable to provide a network between the cassettes and the consoles, to store into the correspondence relation between the cassettes and the consoles a correspondence relation information holding section, which is provided on the network or in the consoles, and to control the cassettes with the consoles.

Moreover, in the present embodiment, it is needless to say that a storage medium to store a program of software of realizing the aforesaid functions of the embodiment is supplied to the system or the apparatus in any of the console 1 and the cassette 5, and the functions can be achieved by the computer (or a CPU or a micro processing unit (MPU)) in the system or the apparatus which computer reads the program stored in the storage medium to execute the program. Moreover, as the storage medium to store the program and the like, storage media such as a nonvolatile memory, a volatile memory backed up by a power supply, a ROM memory, an optical disk, a magnetic disk such as a hard disk, and a magneto-optical disk may be used for storage.

Moreover, it is needless to say that not only the functions of the aforesaid embodiment are realized by the computer that executes read programs, but the functions of the aforesaid embodiment are also realized by the processing of an operating system (OS) (basic system) or the like, which is operating on the computer on the basis of the instruction of the program and executes a part or the whole of the actual processing.

Furthermore, it is needless to say to include the case where a program read from a storage medium is written in a memory equipped with a feature expansion board inserted in a computer or a feature expansion unit connected to the computer and then the CPU or the like equipped in the feature expansion board or the feature expansion unit performs a part or the whole of the actual processing on the basis of the instructions of the program codes to realize the function of the aforesaid embodiment.

Furthermore, such programs may be ones supplied from the outside through a network, a line, or the like. Then, if the programs supplied from the outside are used, the programs may be stored in a storage medium such as a nonvolatile memory, a volatile memory backed up by a power supply, an optical disk, a magnetic disk such as a hard disk, and a magneto-optical disk.

### SECOND EMBODIMENT

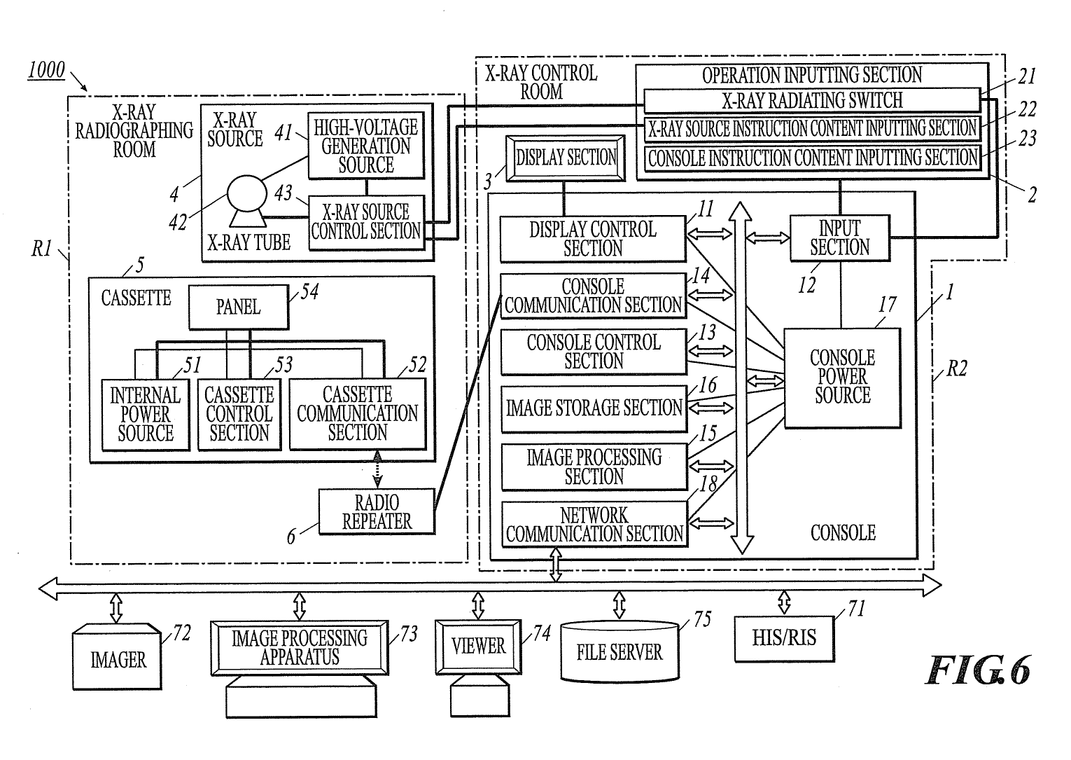

Next, a second embodiment of the X-ray image acquisition system is described with reference to FIG. 6.

The second embodiment differs from the first embodiment in the configuration of the operation inputting section (see FIG. 6). The operation inputting section is composed of an X-ray radiating switch, an X-ray source instruction content inputting section, and a console instruction content inputting section. The X-ray radiating switch and the X-ray source instruction content inputting section are connected to an X-ray source control section, the console instruction content inputting section is connected to the input section of a console. Moreover, a console communication section is connected to a radio repeater, and is not connected to the X-ray source control section unlike the first embodiment. The other configuration is the same as that of the first embodiment described above.

In the second embodiment, a description laying stress on the operation inputting section and the X-ray source control section is performed, and the same respects as those of the aforesaid first embodiment are denoted by the same marks and the detailed descriptions of them are omitted.

FIG. 6 shows the schematic configuration of an X-ray image acquisition system 1000 according to the second embodiment. As shown in FIG. 6, the operation inputting section 2 is provided with an X-ray radiating switch 21 with which an operator inputs a radiography preparation instruction and a radiography instruction, an X-ray source instruction content inputting section 22 with which the operator inputs an instruction content to the X-ray source control section, a console instruction content inputting section 23 with which the operator inputs instruction contents to the console. The instruction contents include X-ray radiography conditions such as an X-ray tube voltage, an X-ray tube current, and an X-ray radiating time; X-ray radiography controlling conditions such as a radiography timing, a radiography part, and a radiography method; image processing conditions; image outputting conditions; cassette selection information; order selection information; subject ID, and the like.

The X-ray source control section 43 and the input section 12 are severally connected to the X-ray radiating switch 21. The X-ray radiating switch 21 includes a first switch for inputting a radiography preparation instruction, and a second switch for inputting a radiography instruction. An instruction with the X-ray radiating switch 21 is input into the X-ray source control section 43 and the input section 12. The X-ray radiating switch 21 has the structure in which inputting with the second switch can be performed after inputting with the first switch.

The X-ray source control section 43 is connected to the X-ray source instruction content inputting section 22. The X-ray source control section 43 drives and controls the high-voltage generation source 41 and the X-ray tube 42 on the basis of an instruction content input from the X-ray source instruction content inputting section 22.

The input section 12 is connected to the console instruction content inputting section 23. An instruction content input into the input section 12 is transmitted t the console control section 13. The console control section 13 drives and controls the console 1 and the cassette 5 on the basis of the received instruction content.

Next, the operation of the X-ray image acquisition system of the second embodiment of the present invention is described.

An operator depresses the first switch of the X-ray radiating switch 21 to input a radiography preparation instruction. The X-ray source control section 43 drives and controls the high-voltage generation source 41 on the basis of the radiography preparation instruction by the first switch to shift the high-voltage generation source 41 to the state of applying a high voltage to the X-ray tube 42. The console control section 13 transmits the radiography preparation instruction to the cassette 5 through the console communication section 14 and radio repeater 6 on the basis of the radiography preparation instruction input into the input section 12 by the first switch. The cassette control section 53 repeats resets at predetermined intervals until a radiography instruction is input on the basis of the received radiography preparation instruction to prevent the storage of electric energy owing to dark currents into the capacitors 5424.

The operator depresses the second switch of the X-ray radiating switch 21 to input a radiography instruction. The X-ray source control section 43 drives and controls the high-voltage generation source 41 to apply a high voltage to the X-ray tube 42 on the basis of the radiography instruction of the second switch, and thereby generates a radiation.

The console control section 13 drives and controls the cassette 5 to perform radiography by the radiations radiated from the X-ray source 4 on the basis of the radiography preparation instruction, which has input into the input section 12 by the first switch.

The X rays radiated from the X-ray source 4 transmit the subject to enter the cassette 5. The cassette 5 acquires X-ray image data on the basis of the X rays that have entered the cassette 5, and transmits the acquired X-ray image data to the console 1 through the radio repeater 6 and the console communication section 14.

As described above, because the cassette 5 of the second embodiment is provided with a plurality of antennas 521, even if there is an antenna 521 that cannot communicate with the radio repeater 6, wireless communication can be performed using another antenna 521 that can communicate with the radio repeater 6.

[Common Matters in Aforesaid Embodiments]

As described above, because a radiation image apparatus includes radiation image acquiring means for acquiring radiation image data by radiation radiography; first communication means for transmitting the radiation image data acquired by the radiation image acquiring means from a first antenna by an electric wave having a frequency exceeding 1 GHz; and second communication means for transmitting the radiation image data acquired by the radiation image acquiring means from a second antenna located at a position different from that of the first antenna by an electric wave, the first communication means can transmit the radiation image data at a high speed by the electric wave having a frequency exceeding 1 GHz large in information transmission capacity. Because the first antenna and the second antenna are located the positions different from each other, even if the position of one antenna is the one arising the multi pass facing or the shadowing, it is rare that the positions of both the antennas are the ones where the multi pass fading and the shadowing arise. Consequently, the generation of the situation in which radiation image data cannot be transmitted owing to a communication impossible condition and a communication poor condition can be made to be little.

Furthermore, the second communication means performs transmission by the electric wave having a frequency exceeding 1 GHz. Consequently, the radiation image data can be transmitted at a high speed by the electric wave having the frequency exceeding 1 GHz large in information transmission capacity by a plurality of communication means. Then, the radiation image data can be transmitted at the high speed in high certainty.

Furthermore, the first communication means and the second communication means can transmit or receive a radiographing signal for acquiring the radiation image data by the radiation radiography. Consequently, the radiographing signal can be timely transmitted or received at high certainty.

Furthermore, the radiation image acquisition apparatus includes a housing made of an electroconductive material, which housing enclosing the radiation image acquiring means, and the antennas of the first communication means and the second communication means are provided to be close to the housing. Consequently, the radiation image acquiring means is prevented from a pressure, a shock, and a deformation, and the plurality of antennas does not disturb radiation radiography. Although strong directivity is produced owing to the housing made of the electroconductive material, the plurality of antennas enables timely communication with high certainty.

Furthermore, because the frequency of the electric wave transmitted from the first communication means differs from the frequency of the electric wave transmitted from the second communication means, even if at one of them the multi pass fading arises, the occurrence of the situation in which radiation image data cannot be transmitted owing to a communication impossible condition or a communication poor condition can be made to be little because the multi pass fading arises at both of the frequencies.

Furthermore, because the first communication means and the second communication means share a communication circuit, it becomes possible to perform timely transmission and reception with high certainty, lowering the cost and miniaturizing.

Furthermore, because the radiation image acquisition apparatus includes a memory to temporarily store the radiation image data acquired from the radiation image acquiring means, even if a communication poor condition or a communication impossible condition arises, it is unnecessary to delay radiation radiography until the communication condition becomes good. Then, it is possible to temporarily store radiation image data in the memory, and to transmit the radiation image data stored in the memory at a communication speed according to the communication condition.

Furthermore, because a cassette is provided with a power source supplying electric power to the first communication means, the second communication means, and the radiation image acquiring means, it becomes possible to perform radiation radiography in a cable-less state having no cables with the other apparatus. Thereby, it is unnecessary to perform radiation radiography with attention paid to the twining of a cable around a subject. Consequently, operationality is good, and radiography efficiency can be improved.

Furthermore, the radiation is an X ray, and the radiation image acquiring means include: an X-ray detector to receive the X ray to output an electric signal; a data converting section acquiring X-ray image data from the electric signal output from the X-ray detector; and an X-ray shielding member disposed on an opposite side of the X-ray detector from a side which is to be radiated with the X ray, the X-ray shielding member absorbing the X ray. Because the quantities of the scattered X rays entering the X-ray detector from the rear thereof can be thereby reduced, the quantities of the scattered X rays entering the radiation image acquiring means from the rear of the X-ray detector can be reduced with the radiated X-ray dose suitably detected with the X-ray detector. Consequently, a clear and good radiation image can be acquired. And, because the plurality of communication means is provided, it is possible to perform timely communication with high certainty, although the X-ray intercepting member, which raises the directivity of wireless communication, is provided.

Furthermore, the radiation image acquisition apparatus is provided with a circuit including the data converting section and the communication circuit of the first communication means and the second communication means, and an internal power source on an opposite side of the X-ray shielding member from a side which is to be radiated with the X ray. Consequently, the dose of the X rays entering the circuit and the power source is suppressed, and the quantity of the X rays scattered by the circuit and the power source and entering the X-ray detector is further suppressed by the X-ray shielding member. Then, good X-ray image data can be acquired.

Furthermore, the radiation image acquisition apparatus selects at least one communication means to which the radiation image data is transmitted among a plurality of communication means including the first communication means and the second communication means for transmitting the radiation image data. Thereby, even if one communication means is in a communication impossible condition or a communication poor condition, radiation image data can be transmitted by selecting another communication means.

Moreover, a radiation image acquisition system includes the aforesaid radiation image acquisition apparatus and a console to receive radiation image data transmitted from the radiation image acquisition apparatus through receiving means for receiving an electric wave transmitted from the radiation image acquisition apparatus. Thereby, the occurrence of the situation in which radiation image data cannot be transmitted owing to a communication impossible condition or a communication poor condition becomes less, and consequently radiation images can be effectively and stably acquired.

Furthermore, the receiving means detects a communication condition of wireless communication, and the console allows display means to perform a display indicating a communication impossible condition when the communication condition of the wireless communication detected by the receiving means. Thereby, if a communication poor condition that is vary rare, even though it may arise, arises, the console allows the display means to perform the display indicating the communication impossible condition, and consequently an operator can directly cope with the situation by adjusting the position of the cassette or the subject or by similar means.

Furthermore, the receiving means detects a communication condition of wireless communication, and the console allows the display means to perform a display indicating a communication poor condition when the communication condition of the wireless communication detected by the receiving means. Thereby, if a communication poor condition that is rare, even though it may arise, arises, the console allows the display means to perform the display indicating the communication poor condition, and consequently an operator can directly cope with the situation by adjusting the position of the cassette or the subject or by similar means.

Incidentally, all of the disclosures including the patent specification, the claims, the attached drawings and the abstract of Japanese Patent Application No. 2005-89058 filed Mar. 25, 2005 are herein incorporated by reference.

### INDUSTRIAL APPLICABILITY

As described above, the present invention can be used in a field in which radiation image radiography is performed, especially in a medical field.

### DESCRIPTION OF MARKS

1000: X-ray image acquisition system
1: console
13: console control section
14: console communication section
16: image storage section
18: network communication section
5: cassette
51: internal power source
52: cassette communication section
521: antenna
522: communication circuit
53: cassette control section
54: panel
545: data converting section
546: memory
549: X-ray shielding member
55: housing
6: radio repeater

1. A radiation image apparatus comprising:
a radiation image acquiring unit to acquire means radiation image data by radiation radiography;
a first communication unit to transmit the radiation image data acquired by the radiation image acquiring unit from a first antenna by an electric wave having a frequency exceeding 1 GHz; and
a second communication unit to transmit the radiation image data acquired by the radiation image acquiring unit m from a second antenna located at a position different from that of the first antenna by an electric wave.

2. The radiation image acquisition apparatus of claim 1, wherein the second communication unit performs the transmission by the electric wave having a frequency exceeding 1 GHz.

3. The radiation image acquisition apparatus of claim 1, wherein the first communication unit and the second communication unit can transmit or receive a radiographing signal for acquiring the radiation image data by the radiation radiography.

4. The radiation image acquisition apparatus of claim 1, further comprising a housing made of an electroconductive material, the housing enclosing the radiation image acquiring unit, wherein
the antennas of the first communication unit and the second communication unit are provided to be close to the housing.

5. The radiation image acquisition apparatus of claim 1, wherein the frequency of the electric wave transmitted from the first communication unit differs from the frequency of the electric wave transmitted from the second communication unit.

6. The radiation image acquisition apparatus of claim 1, wherein the first communication unit and the second communication unit share a communication circuit.

7. The radiation image acquisition apparatus of any one of claim 1, further comprising a memory to temporarily store the radiation image data acquired from the radiation image acquiring unit.

8. The radiation image acquisition apparatus of any one of claim 1, wherein the radiation image acquisition apparatus is a cassette provided with a power source supplying electric power to the first communication unit, the second communication unit, and the radiation image acquiring unit.

9. The radiation image acquisition apparatus of claim 8, wherein the radiation is an X-Ray, and
the radiation image acquiring unit include comprising:
an X-ray detector to receive the X-Ray so as to output an electric signal;
a data converting section to acquire X-Ray image data from the electric signal output from the X-ray detector; and
an X-ray shielding member disposed on an opposite side of the X-ray detector from a side which is to be radiated with the X-Ray, the X-ray shielding member absorbing the X-Ray.

10. The radiation image acquisition apparatus of claim 9, wherein a circuit and the internal power source are provided on an opposite side of the X-Ray shielding member from a side which is to be radiated with the X-Ray, the circuit including the data converting section and the communication circuit of the first communication unit and the second communication unit.

11. The radiation image acquisition apparatus of claim 1, wherein at least one communication unit from which the radiation image data is transmitted is selected among a plurality of communication units including the first communication unit and the second communication unit, so as to transmit the radiation image data.

12. A radiation image acquisition system comprising:
a radiation image acquisition apparatus of claim 1; and
a console to receive radiation image data transmitted from the radiation image acquisition apparatus through a receiving unit to receive an electric wave transmitted from the radiation image acquisition apparatus.

13. The radiation image acquisition system of claim 12, wherein
the receiving unit detects a communication condition of wireless communication, and
the console allows display unit to display information indicating a communication impossible condition when the communication condition of the wireless communication detected by the receiving unit is the communication impossible condition.

14. The radiation image acquisition system of claim 12, wherein
the receiving unit detects a communication condition of wireless communication, and
the console allows the display unit to display information indicating a communication poor condition when the communication condition of the wireless communication detected by the receiving unit is the communication poor condition.
